(19) United States
(12) Patent Application Publication
(10) Pub. No.: US 2025/0390274 A1
(43) Pub. Date: Dec. 25, 2025

(54) SYSTEM AND METHOD FOR PROVIDING AUDIO ZONES IN AN ENVIRONMENT

(71) Applicant: Shure Acquisition Holdings, Inc., Niles, IL (US)

(72) Inventors: Dusan Veselinovic, Chicago, IL (US); Bijal Joshi, Elk Grove Village, IL (US)

(21) Appl. No.: 19/225,575

(22) Filed: Jun. 2, 2025

Related U.S. Application Data
(60) Provisional application No. 63/662,922, filed on Jun. 21, 2024.

(51) Int. Cl. G06F 3/16

(52) U.S. Cl. CPC G06F 3/165

(57) ABSTRACT

Systems and methods are provided herein for receiving audio activity information associated with audio signals generated by at least one microphone included in a plurality of audio devices located within an environment; creating a plurality of audio zones within the environment based on the audio activity information; and based on the audio activity information, assigning each of the plurality of audio zones to one or more of the audio devices. Systems and methods are also provided for creating a plurality of audio zones at locations indicated by one or more user inputs received via a user interface, and based on received audio activity information, assigning each of the plurality of audio zones to one or more of the plurality of audio devices. The plurality of audio zones can comprise one or more inclusion zones for capturing desired audio, and one or more exclusion zones for removing undesired audio.

### CROSS-REFERENCE

This application claims priority to U.S. Provisional Patent Application No. 63/662,922, filed on Jun. 21, 2024, the entirety of which is incorporated by reference herein.

### TECHNICAL FIELD

This disclosure generally relates to an audio system located in a conference room, board room, or other environment, and more specifically, to systems and methods for automatically creating audio zones for the audio system within the environment.

### BACKGROUND

Audio environments, such as conference rooms, boardrooms, and other meeting rooms, video conferencing settings, and the like, can involve the use of multiple microphones or microphone array lobes for capturing sounds from various audio sources and converting the sounds into audio signals. The audio sources may include human speakers, for example. The captured audio signals may be disseminated to a local audience in the environment through speakers (for sound reinforcement) and/or to others located remotely (such as via a telecast, webcast, or the like). For example, persons in a conference room may be conducting a conference call with persons at a remote location. Each of the microphones or array lobes may form a channel. The captured audio signals may be input to an audio processor as multi-channel audio and provided or output by the audio processor as a single mixed audio channel. The audio environment may also include one or more loudspeakers or audio reproduction devices for playing out loud audio signals received, via communication hardware, from the remote participants, or human speakers that are not located in the same room. These and other components of a given audio environment may be included in one or more audio capturing devices (e.g., a conferencing device) and/or operate as part of an audio system.

In general, audio capturing devices are available in a variety of sizes, form factors, mounting options, and wiring options to suit the needs of particular environments. The types of devices, their operational characteristics (e.g., lobe direction, gain, etc.), and their placement in a particular audio environment may depend on a number of factors, including, for example, the locations of the audio sources, locations of listeners, physical space requirements, aesthetics, room layout, and/or other considerations. For example, in some environments, a microphone may be placed on a table or lectern to be near the audio sources and/or listeners. In other environments, a microphone may be mounted overhead or on a wall to capture the sound from, or project sound towards, the entire room, for example.

Typically, the sounds captured in a given environment include speech from the human speakers, as well as unwanted sounds, like errant non-voice or non-human noises in the environment (such as, e.g., sudden, impulsive, or recurrent sounds like shuffling of papers, opening of bags and containers, chewing, sneezing, coughing, typing, etc.), errant voice noises, such as side comments, side conversations between other persons in the environment, etc., far-end speech reproduced or played by one or more loudspeakers in the environment, or other noise interference. To minimize the presence of unwanted sounds in the audio signals captured by the microphones, voice activity detection (VAD) algorithms that detect the presence or absence of human speech or voice in an audio stream may be applied to one or more channels of a microphone, or array lobe. However, the VAD technique may not be effective in removing errant human speech from the desired audio stream, such as, for example, far-end audio playing on the loudspeakers in the environment. An automixer can automatically reduce the strength of a particular microphone's audio input signal to mitigate the contribution of background, static, or stationary noise, when the microphone is not capturing human speech or voice. However, complete, or near complete, rejection of unwanted audio may compromise the performance of existing automixers, since automixers typically rely on relatively simple rules to select which channel to “gate” on, such as, e.g., first time of arrival or highest amplitude at a given moment in time. Noise reduction techniques can be used to reduce certain background, static, or stationary noise, such as fan and HVAC system noises. However, such noise reduction techniques are not ideal for reducing or rejecting errant noises, unwanted speech, and other spurious noise interference.

Accordingly, there is still a need for an audio system or environment that can be configured to optimally capture desired audio and exclude unwanted audio during a conferencing or other meeting event, with minimal setup time, cost, and manual effort, and can be automatically maintained as room and/or participant configurations change.

### SUMMARY

The techniques of this disclosure provide systems and methods designed to, among other things: (1) provide a plurality of audio zones in an environment to ensure optimal handling of audio detected or produced therein, the zones including an inclusion zone for capturing desired audio (e.g., near-end audio, etc.) and an exclusion zone for removing or suppressing undesired audio (e.g., noise, far-end audio, double-talk audio, etc.); (2) create the audio zones either manually, based on user inputs received via a user interface, or automatically, based on audio activity information associated with microphone signals captured in the environment, such as audio source locations, audio quality scores, etc.; (3) automatically assign each audio zone to one or more audio devices within the environment based on the audio activity information, such as relative positioning of the audio deice, the type of audio device, the type of audio activity, etc.; (4) perform additional processing to correct off-axis audio included in audio signals captured in a modification zone of the environment; and (5) use the audio zones to further enhance other performance aspects of the audio system, such as, for example, operation of audio processors, cameras, and other devices.

One exemplary embodiment includes a method using one or more processors in communication with a plurality of audio devices located within an environment, the audio devices comprising at least one microphone, the method comprising: receiving audio activity information associated with audio signals generated by the at least one microphone; creating a plurality of audio zones within the environment based on the audio activity information; and based on the audio activity information, assigning each of the plurality of audio zones to one or more of the audio devices, wherein the plurality of audio zones comprise one or more inclusion zones for capturing desired audio, and one or more exclusion zones for removing undesired audio.

Another exemplary embodiment includes a method using one or more processors in communication with a user interface and a plurality of audio devices located within an environment, the audio devices comprising at least one microphone, the method comprising: creating a plurality of audio zones within the environment at locations indicated by one or more user inputs received via the user interface; receiving audio activity information associated with audio signals generated by the at least one microphone; and based on the audio activity information, assigning each of the plurality of audio zones to one or more of the plurality of audio devices, wherein the plurality of audio zones comprise one or more inclusion zones for capturing desired audio, and one or more exclusion zones for removing undesired audio.

According to some aspects, the audio activity information comprises an audio source location and an audio quality score for a given audio signal, and the above-described method further comprises: based on the audio quality score indicating the presence of off-axis audio, creating a modification zone at or near the corresponding audio source location; and processing the given audio signal to correct the off-axis audio.

Another exemplary embodiment includes an audio system located in an environment, the audio system comprising a plurality of audio devices including at least one microphone configured to capture audio signals; and one or more processors in communication with the plurality of audio devices, the one or more processors configured to: receive audio activity information associated with the audio signals generated by the at least one microphone; create a plurality of audio zones within the environment based on the audio activity information; and based on the audio activity information, assign each of the plurality of audio zones to a select one of the plurality of audio devices, wherein the plurality of audio zones comprises: one or more inclusion zones for capturing desired audio, and one or more exclusion zones for removing undesired audio.

Another exemplary embodiment includes an audio system located in an environment, the audio system comprising a plurality of audio devices including at least one microphone configured to capture audio signals; a user interface configured to receive one or more user inputs; and one or more processors in communication with the user interface and the plurality of audio devices, the one or more processors configured to: create a plurality of audio zones within the environment at locations indicated by the one or more user inputs; receive audio activity information associated with the audio signals generated by the at least one microphone; and based on the audio activity information, assign each of the plurality of audio zones to a select one of the plurality of audio devices, wherein the plurality of audio zones comprises: one or more inclusion zones for capturing desired audio, and one or more exclusion zones for removing undesired audio.

Another exemplary embodiment includes a non-transitory computer-readable storage medium comprising instructions that, when executed by one or more processors, cause the one or more processors to perform: receiving audio activity information associated with audio signals generated by the at least one microphone; creating a plurality of audio zones within the environment based on the audio activity information; and based on the audio activity information, assigning each of the plurality of audio zones to one or more of the audio devices, wherein the plurality of audio zones comprise one or more inclusion zones for capturing desired audio, and one or more exclusion zones for removing undesired audio.

Another exemplary embodiment includes a non-transitory computer-readable storage medium comprising instructions that, when executed by one or more processors, cause the one or more processors to perform: creating a plurality of audio zones within the environment at locations indicated by one or more user inputs received via the user interface; receiving audio activity information associated with audio signals generated by the at least one microphone; and based on the audio activity information, assigning each of the plurality of audio zones to one or more of the plurality of audio devices, wherein the plurality of audio zones comprise one or more inclusion zones for capturing desired audio, and one or more exclusion zones for removing undesired audio.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a block diagram illustrating a top view of an exemplary audio environment having a plurality of audio zones, in accordance with one or more embodiments.

FIG. 2 is a block diagram illustrating a side view of the audio environment of FIG. 1, in accordance with one or more embodiments.

FIG. 3 is a block diagram illustrating an exemplary audio system, in accordance with one or more embodiments.

FIG. 4 is a flowchart illustrating an exemplary process for automatically configuring audio zones for an environment, in accordance with one or more embodiments.

### DETAILED DESCRIPTION

In general, audio systems ensure optimal audio coverage of a given environment by delineating one or more “audio coverage areas,” or a region within which a designated microphone can deploy beamformed audio pick-up lobes for capturing sounds, including speech produced by human speakers. The sounds captured by the audio pick-up lobes are converted to audio signals that may be provided to respective channels of an automixer to generate a desired audio mix. A given environment or room can include one or more audio coverage areas, depending on the size, shape, and type of environment. Each of those audio coverage areas may be assigned to a particular microphone, and each microphone (or array microphone) may have one or more designated audio coverage areas, depending on proximity and other factors. For example, in a typical conference room, there may be a single audio coverage area that includes the seating areas around a conference table, while in a typical classroom, a first audio coverage area may include the space around a blackboard and/or podium at the front of the room, and a second audio coverage area may include the desks or seats facing the front of the room, or other audience location. Some audio systems have fixed audio coverage areas that are manually set up by a system designer or installer, while other audio system are configured to dynamically create audio coverage areas for a given environment.

When a detected audio source falls outside an audio coverage area, some existing audio systems simply refrain from deploying a lobe towards the source location and rely on the natural decay of an audio signal to prevent, or at least minimize, detection of such “out-of-coverage” sounds by nearby active lobes. However, in some cases, the out-of-coverage sounds, which can include human speech and/or noise, may bleed or leak into the audio captured by the “in-coverage” lobes (also known as “acoustic bleeding”) and thus, may be present in the desired audio mix as “off-axis” noise. For example, in double-talk scenarios, or when a person inside the audio coverage area and another person located just outside the audio coverage area are talking at the same time, the lobes focused within the audio coverage area may capture both the in-coverage speech and the out-of-coverage speech. Double-talk audio may also be present in far-end interference scenarios, or when a loudspeaker signal containing far-end audio is picked-up by the microphones and transmitted to the far-end participants, thus resulting in an undesirable echo. In either case, the unwanted double-talk audio may also present problems with appropriate automixer channel selection, which attempts to avoid errant noises while still selecting the channel(s) that contain voice. Accordingly, some audio systems are configured to actively remove off-axis audio and other voice noise from a desired audio mix captured within the audio coverage area, for example, by using the “out-of-coverage” sounds to generate a mask for removing off-axis noise from in-coverage audio signals, for example, as described in co-owned U.S. patent application Ser. No. 18/397,693, the entire contents of which are incorporated by reference herein. However, audio coverage areas are specific to individual microphones and thus, do not impact the operation of other types of audio devices in the environment (e.g., loudspeakers, etc.), nor do they convey information about other areas of the environment, such as the locations of persistent noise sources (e.g., HVAC, etc.).

Off-axis speech audio may also be present within an audio coverage area, for example, when a talker is talking with their back to the microphone or while positioned sideways with respect to the microphone (i.e. facing away from the microphone), rather than talking “on-axis” (i.e. directly facing the microphone). In such cases, the off-axis audio may include desired audio that can be extracted or enhanced, for example, by removing or suppressing lower quality/low intelligibility audio. Some regions of a given environment may be more likely to produce such off-axis audio, for example, due to the positioning of walls, tables, chairs, and other furniture in the conference room. In some cases, off-axis audio may be further deteriorated by the presence of surface reflections. In some cases, the surface reflections, themselves, may generate off-axis audio.

For example, in a conference room equipped with a blackboard on a wall, a person speaking while approaching or standing next to the blackboard may produce off-axis audio due their speech, or voice audio, reflecting off of the blackboard. Thus, there are several types of off-axis audio, both in-coverage and out-of-coverage, that may diminish the quality or intelligibility of desired audio.

Systems and methods are provided herein for providing a plurality of audio zones in an environment to ensure optimal handling of audio signals present throughout the environment. In particular, each audio zone is configured to handle a specific type of audio (e.g., near-end audio, far-end audio, human speech, noise, etc.), and each audio zone is assigned to certain audio devices (e.g., microphone(s), loudspeaker(s), etc.) and/or other audio sources (e.g., persistent noise sources, etc.) in the environment, so that similar audio processing rules can be employed to handle similar types of audio across multiple devices. The use of audio zones can also speed up, and make more efficient, the installation and set-up procedures for both new environments and existing environments undergoing changes (e.g., different orientation or layout of tables, chairs, desks, audio devices, etc.). In addition, because the audio zones are configured to provide improved handling of different types of audio signals (e.g., near-end, far-end, noise, and off-axis audio), the audio zones can also be used to improve operation of other audio processing algorithms in the environment (such as, e.g., echo cancellation, audio mixing, automatic gain adjustment, sound reinforcement, etc.). According to embodiments, the audio zones may be created manually, based on user inputs received from a user interface, or automatically, based on audio activity information associated with audio signals captured by at least one microphone in the environment. In either case, the received audio activity information can be used to automatically assign each of the audio zones to one or more of the audio devices in the environment, for example, based on the type of audio activity detected, a proximity to the audio zone or other distance information, and/or the type of audio device. For example, the audio zones may comprise one or more inclusion zones for capturing desired audio produced within the environment, such as, e.g., “near-end” audio signals produced by local conference participants, and one or more exclusion zones for removing or attenuating undesired audio detected within the environment, such as, e.g., “far-end” audio signals playing on one or more loudspeakers. The audio zones may partially or entirely overlap with one or more audio coverage areas implemented in the same environment. In some cases, the audio zones further comprise one or more modification zones for removing undesired audio from audio signals captured outside an inclusion zone but within an audio coverage area, such as, for example, in the case of off-axis audio or other audio signal comprising both desired and undesired audio.

In embodiments, the environment comprises a plurality of audio devices that are part of a larger audio system used to facilitate a conferencing operation (such as, e.g., a conference call, telecast, webcast, etc.) or other audio/visual event. In some cases, the audio system may be configured to operate as an ecosystem comprised of the plurality of audio devices and a computing device that is in communication with each of the audio devices, for example, using a common communication protocol. The audio devices may include at least one microphone, at least one loudspeaker, and/or one or more conferencing devices. In various embodiments, the computing device comprises at least one processor configured to automatically create and/or dynamically modify a plurality of audio zones for the environment, assign each audio zone to specific audio devices and/or audio sources based on audio activity information received from the at least one microphone, or a combination thereof.

As used herein, the terms “lobe” and “microphone lobe” refer to a beamformed audio beam generated by a given microphone array (or array microphone) to pick up sounds at a select location, such as the location towards which the lobe is directed. While the techniques disclosed herein are described with reference to microphone lobes generated by array microphones, the same or similar techniques may be utilized with other forms or types of microphone coverage (e.g., a cardioid pattern, etc.) and/or with microphones that are not array microphones (e.g., a handheld microphone, boundary microphone, lavalier microphones, etc.). Thus, the term “lobe” is intended to cover any type of audio beam or coverage.

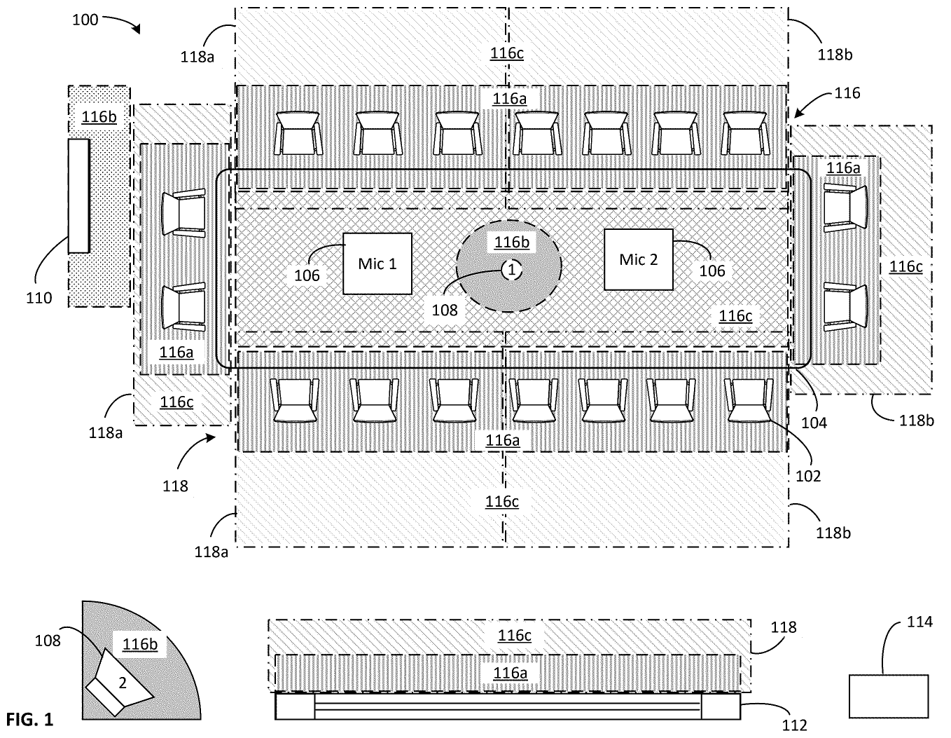

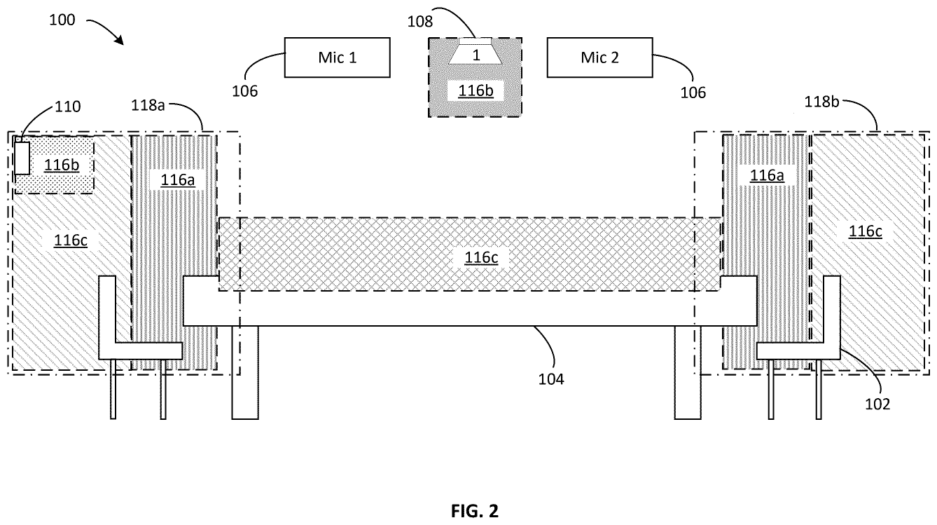

Referring now to FIGS. 1 and 2, shown are schematic diagrams of an exemplary environment 100 in which one or more techniques for implementing a plurality of audio zones may be used to ensure optimal handling of audio signals captured or produced throughout the environment, in accordance with embodiments. In particular, FIG. 1 depicts a top view of the environment 100, while FIG. 2 depicts an exemplary side view of the same. The environment 100 may be a conference room, a boardroom, a classroom, or any other meeting room or event space where the audio sources include one or more human speakers or talkers participating in a conference call, telecast, webcast, class, workshop, seminar, webinar, or other meeting or event. The audio sources may be seated in respective chairs 102 disposed around a table 104, as shown in FIG. 1. While FIGS. 1 and 2 show a specific room configuration, it should be appreciated that other arrangements of the audio zones, audience and presenter areas, audio devices and/or other audio sources are contemplated and possible, including, for example, audio sources that move about the room and different arrangements of the chairs 102 and/or table(s) 104.

The environment 100 further comprises one or more microphones 106 configured to generate a plurality of audio signals by detecting or capturing sound from audio sources and converting the sound into audio signals. The audio sources may include, for example, human speakers situated in the environment 100 and participating in a conference call or other meeting or event (such as, e.g., near-end conference participants seated around the table 104). The sounds may include speech, or other human voice audio, spoken by the human speakers, music or other sounds produced by the human speakers, and other near-end sounds associated with the conference call or other event. In some embodiments, the microphone(s) 106 may include or be communicatively coupled to a beamformer (not shown) for processing the audio signals generated based on the captured audio, or otherwise generating one or more beamformed audio signals. In such cases, the microphone(s) 106 may be configured to deploy or direct a plurality of audio pick-up beams, or microphone lobes, towards various locations, or at various angles relative to the microphone(s) 106, and the beamformer may be configured to generate the beamformed audio signals by directing one or more of the microphone lobes towards a particular location in the environment 100 (e.g., towards a selected audio source). The beamformer may be included in the microphone(s) 106 or may be a standalone device communicatively coupled to the microphone(s) 106. The beamformer may include any type of beamforming algorithm or other beamforming technology configured to deploy microphone lobes, including, for example, a delay and sum beamforming algorithm, a minimum variance distortionless response (“MVDR”) beamforming algorithm, and more. When multiple microphone lobes are used, the beamformer may include a plurality of audio channels, and each channel may be assigned to a respective lobe for individually receiving the audio signal generated using the audio captured by that lobe. For example, each microphone 106 can be configured to capture a plurality of audio signals and provide each of the plurality of audio signals to a respective one of a plurality of audio channels at the beamformer. In other embodiments, a beamformer may not be used, for example, in cases where the microphone(s) 106 include a plurality of omnidirectional microphones, each configured to capture audio signals using an omnidirectional lobe.

For ease of explanation, the techniques described herein may refer to using a plurality of audio signals captured by the microphone(s) 106, even though the techniques may actually utilize any type of acoustic source, including beamformed audio signals generated by the beamformer. In addition, or alternatively, the plurality of audio signals captured by the microphone(s) 106 may be converted into the frequency domain, in which case, certain components of the audio system may operate in the frequency domain.

Each microphone 106 may include one or more of an array microphone (e.g., comprised of a plurality of microphone transducers or elements), a non-array microphone (e.g., directional microphones such as lavalier, boundary, etc.), or any other type of audio input device capable of capturing speech and other sounds. The type, number, and placement of microphone(s) in a particular environment may depend on the locations of audio sources, listeners, physical space requirements, aesthetics, room layout, stage layout, and/or other considerations. Thus, the microphone(s) 106 may be placed in any suitable location of the environment 100, including on a ceiling, wall, table, lectern, and/or any other surface of the environment 100, such as, for example, the table 104, and may conform to a variety of sizes, form factors, mounting options, and wiring options to suit the needs of the particular environment. For example, in the illustrated embodiment, the microphone(s) 106 comprises a first microphone 106 and a second microphone 106 mounted to, or suspended from, the ceiling above the table 104 in order to capture near-end audio generated by the human speakers seated in the chairs 102 or otherwise disposed around the table 104, as shown in FIGS. 1 and 2. In other embodiments, the one or more microphones 106 may be disposed in a single microphone array or other audio device, or in more than two microphones and/or other audio devices, for example.

The environment 100 also comprises one or more loudspeakers 108 for playing or broadcasting far-end audio signals received from audio sources that are not present in the environment 100 (such as, e.g., remote conference participants connected to the conference call through third-party conferencing software). The far-end audio signals may include human voice or speech audio produced by the remote participants, or other remote audio signals associated with the event. In various cases, the sounds captured by the microphone(s) 106 may include the far-end audio signals (or “loudspeaker signals”) output by the loudspeaker(s) 108, in addition to the near-end audio signals produced by the talkers in the environment 100. The loudspeaker(s) 108 may be disposed at various locations around the environment 100 depending on its configuration, as shown in FIG. 1. In embodiments, the one or more loudspeakers 108 may be attached to the ceiling, attached to a wall, or placed on any other surface in the environment 100, such as, for example, the table 104, a lectern or podium, a desk or other tabletop, and the like. For example, in the illustrated embodiment, a first loudspeaker 108 are mounted to, or suspended from, the ceiling (e.g., as shown in FIG. 2), while a second loudspeaker 108 is attached to one or more walls in a corner of the environment 100 (e.g., as shown in FIG. 1).

Other audio sources may also be present in the environment 100, including audio sources that produce undesirable sounds or audio, such as, e.g., noise from a ventilation system, other human speakers that are in the background and/or are not part of the conferencing event, audio/visual equipment, electronic devices, etc. For example, FIGS. 1 and 2 show a noise source 110 located on one side of the environment 100 that may be a heating, ventilation, and air-conditioning (HVAC) unit or vent and thus, may be a source of persistent noise in the environment 100.

The environment 100 can also include a presentation unit 112 for displaying video, images, or other content associated with the conference call or other event, such as, for example, a live video feed of the remote conference participants, a document being presented or shared by one of the participants, a video or film being played as part of the event, etc. In some embodiments, the presentation unit 112 may be a smart board or other interactive display unit. In other embodiments, the presentation unit 112 may be a television, computer monitor, or any other suitable display screen. In still other embodiments, the presentation unit 112 may be a chalkboard, whiteboard, or the like. The presentation unit 112 may be attached to one of the walls, as shown in FIG. 1, attached to the ceiling, or placed on one or more other surfaces within the environment 100, such as, for example, the table 104, a lectern, a desk or other tabletop, and the like. In some embodiments, at least one of the microphone(s) 106 may be coupled to, integrated into, or otherwise disposed on or near the presentation unit 112, for example, in order to capture speech produced by a presenter or human speaker positioned at or near the presentation unit 112. Likewise, in some embodiments, at least one of the loudspeaker(s) 108 may be coupled to, integrated into, or otherwise disposed on or near the presentation unit 112 (e.g., instead of placing the second loudspeaker 108 in the corner of the environment 100 as shown in FIG. 1), for example, in order to play audio associated with a video or other presentation displayed on the presentation unit 112.

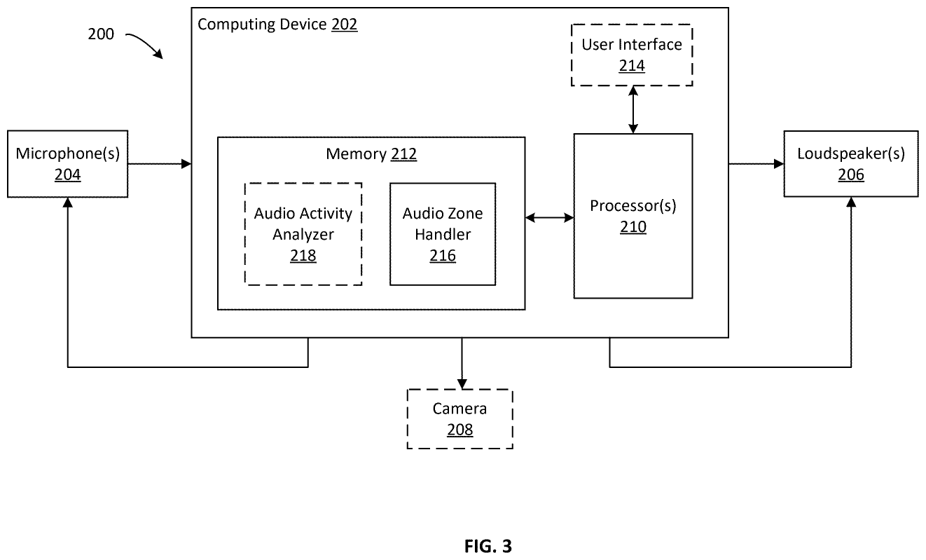

As shown in FIG. 1, the environment 100 may further include a computing device 114 for enabling a conferencing call or otherwise implementing one or more aspects of the conference call or other event. The computing device 114 can be any generic computing device comprising a processor and a memory device (e.g., as shown in FIG. 3). In embodiments, the one or more microphones 106 and the one or more loudspeakers 108 (collectively referred to herein as “audio devices”), as well as one or more other components of the environment 100 (such as, e.g., the presentation unit 112) may be connected or coupled to the computing device 114 via a wired connection or a wireless network connection. The computing device 114 may be located anywhere in the environment 100, including, for example, on the table 104 (e.g., as a laptop or tablet computer), on another surface or counter, in a separate unit or cabinet, integrated into or coupled to the presentation unit 112, etc. Though not shown, it should be appreciated that the conferencing environment 100 may include other devices not shown in FIG. 1, such as, for example, one or more sensors (e.g., motion sensor, infrared sensor, etc.), a video camera (e.g., camera 208 shown in FIG. 3), etc.

In embodiments, the computing device 114, the one or more microphones 106, the one or more loudspeakers 108, and any other audio devices in the environment 100 form an audio system (such as, e.g., audio system 200 shown in FIG. 3) configured to implement the audio zones 116 for optimally handling different types of audio signals present in the environment 100. Each audio zone 116 may be a three-dimensional region or space delineated within the environment 100, by the computing device 114 or other processor, and assigned certain audio processing tasks and/or other characteristics depending on the type of audio associated with that zone 116. As shown in FIG. 2, the audio zones 116 may extend three-dimensionally in order to fully cover the designated region, such as the area above the table 104, the areas around each of the chairs 102, the space surrounding each loudspeaker 108, etc.

The audio zones 116 can comprise one or more inclusion zones 116a for capturing desired audio signals, such as, for example, near-end speech and other audio generated by human speakers seated in the chairs 102 or otherwise near the table 104, located at or near the presentation unit 112, or elsewhere in the environment 100. In the illustrated embodiment, the audio zones 116 include a plurality of inclusion zones 116a in order to cover multiple desired audio sources located throughout the environment 100, such as, e.g., near-end talkers or local participants of a conference call or meeting. For example, as shown in FIG. 1, a set of first inclusion zones 116a may be formed around the table 104 in order to capture participants or talkers seated in the chairs 102 arranged along the four sides of the table 104, while a second inclusion zone 116a may be formed in front of the presentation unit 112 to capture a presenter or other talker situated near the presentation unit 112.

In general, the audio system can be configured to allow capture of sounds present within the inclusion zones 116a by enabling those sounds, or desired audio, to be detected by the microphone(s) 106 or otherwise be included in the audio signals output by the microphone(s) 106 (i.e. “microphone signals”). For example, the desired audio may be captured using one or more audio processing techniques, such as directing audio pick-up lobes towards the inclusion zones 116a; gating on the audio channels that correspond to (or carry audio detected by) the audio pick-up lobes directed towards the inclusion zones 116a; boosting, or increasing a gain level of, any audio signals generated based on audio detected within the inclusion zones 116a; or any other suitable technique.

The audio zones 116 can also comprise one or more exclusion zones 116b for removing, attenuating, or suppressing noise and other undesired audio. Examples of undesired audio include HVAC noise from the noise source 110, other persistent non-vocal sounds, far-end speech and other audio playing on the loudspeaker(s) 108, and other unwanted vocal sounds present in the environment 100. In the illustrated embodiment, the audio zones 116 include a plurality of exclusion zones 116b in order to cover, or handle, multiple noise sources located in different areas of the environment 100. As an example, audio signals played over the loudspeaker(s) 108 become a source of noise when the loudspeaker audio is picked up by the microphone(s) 106. Accordingly, a first exclusion zone 116b (also referred to as a first far-end zone) may be formed around the first loudspeaker 108 located above the table 104 to prevent audio playing on the first loudspeaker 108 from being picked up by either of the first and second microphones 106 disposed above the table 104. Likewise, a second exclusion zone 116b (also referred to as a second far-end zone) may be formed around the second loudspeaker 108 located near the presentation unit 112 in order to prevent audio playing on the second loudspeaker 108 from being picked up by a microphone of the presentation unit 112, if any, or any other microphone 106 in the environment 100. As another example, HVAC and other persistent noise produced by the noise source 110 may be a known source of noise in the environment 100. Accordingly, a third exclusion zone 116b (also referred to as HVAC zone) may be formed around the noise source 110 in order to prevent the HVAC noise from being picked up by, for example, the first microphone 106.

In general, the audio system can be configured to allow removal, suppression, or attenuation of the sounds present within the exclusion zones 116b by excluding those sounds, or undesired audio, from the audio signals output by the microphone(s) 106 (or “microphone signals”), or otherwise preventing those sounds from entering the microphone signals. For example, the undesired audio may be excluded using one or more audio suppression or other processing techniques, such as muting the audio channels that correspond to (or carry audio detected by) the audio pick-up lobes that are directed towards the exclusion zones 116b, disabling any audio pick-up lobes directed towards the exclusion zones 116b, applying a mask or other device configured to acoustically cancel out or suppress any audio present in the exclusion zones 116b, attenuating, or reducing a gain level of, any audio signals generated based on audio detected within the exclusion zones 116b, or any other suitable technique. In some cases, undesired audio may be excluded from the microphone signals by avoiding deployment, or the directing of audio pick-up lobes, in the direction of exclusion zones 116b, applying beamforming (e.g., MVDR) nulls to the exclusion zones 116b, and/or applying the gate-inhibiting technique to minimize the gating of lobes directed towards exclusion zones 116b.

In various embodiments, the audio zones 116 may further include one or more modification zones 116c for processing or handling captured audio signals that comprise off-axis audio, acoustic reflections, and/or other audio that requires additional enhancement, redirection, or other processing. In some cases, the modification zones 116c may be configured so that the captured audio signals are processed by removing undesired audio, extracting desired audio, redirecting or enhancing the off-axis audio to obtain a desired audio signal, or otherwise correcting the off-axis noise included in the signals. As shown in FIGS. 1 and 2, some of the modification zones 116c may be positioned around or near the inclusion zones 116a in order to be optimally positioned to capture the off-axis audio.

In some cases, off-axis audio may be generated when voice sounds are produced by a talker located in the same audio coverage area 118 but facing away from the microphone 106 that detected the audio signal. In other cases, off-axis audio is generated when a near-end talker moves outside the inclusion zones 116a, but is still within an audio coverage area 118 and thus, in range of an audio pick-up lobe deployed by the microphone(s) 106, for example.

More specifically, as shown in FIGS. 1 and 2, the environment 100 also includes a plurality of audio coverage areas 118 (also referred to herein as “audio pick-up regions”) that define the regions within which the microphone(s) 106 can deploy or direct beamformed audio pick-up lobes for capturing audible sounds produced by one or more audio sources. To help ensure that the audio pick-up lobes are directed towards desired audio sources, the audio coverage areas 118 may be configured to encompass expected locations of near-end participants and/or other desired audio sources, such as, for example, the chairs 102 in which participants may be seated, areas near or around the table 104, and/or the area near the presentation unit 112 or other podium or platform in the environment 100. In the illustrated embodiment, for example, several of the audio coverage areas 118 include the areas around the chairs 102 and portions of the table 104 that are closest to the chairs 102, while another audio coverage area 118 includes the area in front of the presentation unit 112.

In embodiments that include multiple microphone arrays 106, each audio coverage area 118 may be assigned to a select one of the microphones 106 depending on a proximity to the audio source(s) and/or other factors that determine optimal capture of desired audio sources by the audio pick-up lobes. For example, in FIGS. 1 and 2, the audio coverage areas 118 comprise first audio coverage areas 118a that are assigned to the first microphone 106 because the first areas 118a are located closer to the first microphone 106. Likewise, the audio coverage areas 118 further comprise second audio coverage areas 118b that are assigned to the second microphone 106 because the second areas 118b are located closer to the second microphone 106. Using these and other techniques, for example, as described in co-owned U.S. patent application Ser. No. 18/151,346, the contents of which are incorporated by reference herein, the audio coverage areas 118 can be configured to enable the microphones 106 to specifically and optimally capture sounds produced by near-end participants, or talkers, and desired audio sources.

In most cases, a given microphone 106 will detect sounds produced by audio source(s) that are located with the audio coverage area 118 assigned to that microphone 106 and will deploy, direct, and/or activate an audio pick-up lobe towards the detected audio source location accordingly. In some cases, however, the microphone 106 may also detect off-axis audio, such as sounds produced by an audio source located outside the audio coverage area 118 but strong enough to be audible within the assigned audio coverage area 118 and thus, picked up by the lobes deployed within that area 118 (also known as “acoustic bleeding”). Such sounds, or “out-of-coverage audio,” may include, for example, near-end speech from a talker located in an adjacent audio coverage area 118.

Another form of off-axis audio may be acoustic reflections. Acoustic reflections may appear to be produced by audio sources located outside the inclusion zones 116a but are actually near-end speech (e.g., produced by talkers seated in the chairs 102, or otherwise positioned around the table 104) that reflected off of a reflective surface in the environment 100 (e.g., the table 104). Such off-axis audio may be detected by a given microphone 106 if the reflected audio signals are strong enough to be audible within, or picked up by, the audio coverage area 118 assigned to that microphone 106. For example, acoustic reflections (or “table reflections”) may be produced when a talker speaks into an object, such as, the table 104 or other reflective surface in the environment 100 (e.g., countertop, laptop, etc.), and the talker's speech reflects off of the object with little or no distortion. When captured by the one or more microphones 106, acoustic reflections can interfere with or degrade a sound quality of the desired audio captured within the assigned audio coverage area 118. In embodiments that include a camera with talker tracking capabilities, the acoustic reflections may cause the camera to track the talker to the wrong location, create jitter, or otherwise degrade camera performance.

According to embodiments, the modification zone(s) 116c may comprise one or more first modification zones 116c (also referred to as “off-axis zones”) configured to enable audio processing of off-axis audio captured within an audio coverage area 118 but outside the inclusion zones 116a. For example, the first modification zones 116c may be located at or around one or more perimeters of the inclusion zones 116a, as shown in FIGS. 1 and 2. The modification zones 116c may further include a second modification zone 116c (also referred to as “table reflection zone”) that is located at the center of the table 104 and is configured to enable additional audio processing of table reflections and other acoustic reflections detected in that region, as shown in FIGS. 1 and 2.

In various embodiments, the audio system can be configured to process audio signals captured within the modification zones 116c by correcting or mitigating the off-axis audio included in the captured signals. For example, the off-axis audio may be corrected by removing or attenuating any undesired audio, extracting or enhancing any desired audio, and/or otherwise improving an audio quality of the captured audio signals. In some cases, off-axis audio may be mitigated by increasing an amount of gain applied to an audio signal detected as including off-axis audio (e.g., based on the localization score). In some cases, the off-axis audio may be mitigated by using a different microphone to capture a particular talker, such as, for example, one that is angled towards the front of the talker (rather than the talker's side or back), or is otherwise more on-axis for that particular talker. In some embodiments, the off-axis audio may be corrected using one or more audio processing techniques, such as, e.g., applying a mask to the captured audio signal that is generated based on the out-of-coverage audio and in-coverage audio, for example, as described in co-owned U.S. patent application Ser. No. 18/397,693, the entire contents of which are incorporated by reference herein. As another example, the effect of acoustic reflections in the captured audio signal may be corrected or minimized by applying one or more audio processing techniques, such as, e.g., adjusting the audio source location (or corresponding “talker coordinates”) based on height information associated with the environment 100, for example, as described in co-owned U.S. Patent Application No. 63/514,046, the entire contents of which are incorporated by reference herein.

In some embodiments, the plurality of audio zones 116 can be manually implemented or created by a user, for example, based on one or more user inputs received via a user interface of the audio system and/or the computing device 114 (such as, e.g., user interface 214 of FIG. 3). For example, the audio system and/or the computing device 114 may include one or more processors (such as, e.g., processor(s) 210 of FIG. 3) configured to generate and present a graphical user interface or other tool for drawing, placing, or otherwise configuring the audio zones 116 for the environment 100. The one or more processors may be in communication with the user interface (e.g., a touchscreen, mouse, keyboard, and/or other input device) in order to receive the user inputs or other user interaction with the tool, and a display screen of the audio system and/or the computing device 114 (not shown) for displaying the graphical user interface tool for the user. The tool may be configured to enable the user to select a location in the environment 100 for placing each audio zone 116; select the type of audio the audio zone 116 will handle; assign each audio zone 116 to an appropriate audio device(s) (e.g., microphones 106 and/or loudspeakers 108); and/or other suitable actions for setting up the audio zones 116. Once the setup is complete, the one or more processors may implement the audio zones 116 within the environment 100 as instructed by the user.

In other embodiments, the audio zones 116 can be automatically implemented or created by the one or more processors of the audio system and/or the computing device 114. For example, the audio system can be configured to create the plurality of audio zones 116 within the environment 100 based on audio activity information associated with the audio signals captured by the at least one microphone 106. The audio activity information may be received at the one or more processors directly from the at least one microphone 106, or other audio device in the environment 100, and/or from an audio activity analyzing component of the audio system that is in communication with the at least one microphone 106 and/or the other audio devices. More specifically, the audio activity analyzing component (or “audio activity analyzer,” as shown in FIG. 3) can be configured to aggregate or collect the audio activity information over a period of time from various audio devices in the environment 100 and analyze or assess the audio activity information for the purpose of audio zone creation, adjustment, and/or other configuration. In some embodiments, at least a portion of the audio activity information may be received directly from the at least one microphone 106 or other audio device configured to generate sound localization data or other pertinent location data, as described below.

The audio system may further comprise an audio zone handling component (or “audio zone handler,” as shown in FIG. 3) configured to create, define, adjust, or otherwise configure the audio zones 116, and implement the audio zones 116 accordingly within the environment 100, in accordance with the techniques described herein. In embodiments where the audio zones 116 are automatically created, the audio zone handler may be configured to create and/or define the audio zones 116 based on the received audio activity information. For example, the audio zone handler may be in communication with the audio activity analyzer, and/or the microphone(s) 106, in order to receive the audio activity information for configuring the audio zones 116. In embodiments where the audio zones 116 are created or adjusted based on user input, the audio zone handler may be configured to generate and/or present the graphical user interface tool that enables user control of the audio zones 116, and create the audio zones 116 at the locations indicated by the received user inputs.

In some embodiments, the audio zone handler may be further configured to enable a user to control or change one or more aspects of existing audio zones 116, regardless of whether the zone 116 is created automatically or manually. For example, the audio zone handler may be configured to generate and/or present a graphical user interface or other tool (e.g., same as or different from the tool for manual zone creation) for moving, adjusting, reshaping, or otherwise changing one or more boundaries of the existing audio zones 116. The user may interact with the graphical tool via a display screen and/or user interface of the computing device 114 and/or audio system, and the one or more processors may be configured to receive the user input from the user interface and implement the adjustment using the audio zone handler.

According to embodiments, each of the audio activity analyzer and the audio zone handler may be a software module executed by one or more processors of the audio system and/or computing device 114 (e.g., an audio processor). All or a portion of each module may be stored in a memory of the computing device 114, another component of the audio system (e.g., one or more of the microphones 106), or other processing component of the audio system. In some cases, all or a portion of each of the audio activity analyzer and the audio zone handler may be stored in a cloud computing device or system (not shown) that is in communication with the one or more processors or other component of the audio system. In some embodiments, via the cloud computing system, the audio activity analyzer may be configured to receive data from multiple different rooms or environments, and the audio zone handler may be configured to create and assign audio zones based on the aggregated data.

In some embodiments, the audio activity analyzer may be configured to collect audio activity information for audio signals generated based on audio detected in the environment 100 during a predefined setup procedure. The setup procedure may include, for example, playing audio signals that are test signals over the loudspeaker(s) 108 (e.g., to identify the areas where loudspeaker exclusion zones 116b should be placed) and/or having test subjects (e.g., talkers or other audio sources) produce audio while seated in the chairs 102, positioned around the table 104, or otherwise located in different areas of the environment 100 (e.g., to identify the areas where near-end inclusion zones 116a and/or off-axis modification zones 116c should be placed).

In some embodiments, the audio activity analyzer may be configured to collect audio activity information over a longer period of time, or otherwise generate a historical data collection that may be stored in a memory of the audio system and/or the computing device 114 and used to generate statistical data about the audio activity present in the environment 100. For example, statistical analysis of the collected data may reveal certain behavioral patterns for the audio sources in the environment 100, such as, e.g., consistent or frequent locations for near-end talkers, regular or persistent locations for far-end audio and other noise sources, and/or repeated or common locations for off-axis audio. In such cases, the audio activity analyzer may be further configured to analyze and/or process the collected data to identify patterns and other statistical data useful for predicting the locations of audio sources and/or placement of the audio zones 116.

The audio activity information used to create, adjust, and/or assign the audio zones 116 can comprise an audio source location for each audio signal generated by the at least one microphone 106. In some embodiments, the microphone(s) 106 can be configured to detect one or more audio sources in the environment 100 and generate location data (also referred to as “sound localization data”) that indicates a position of each audio source relative to the detecting microphone 106, or the audio source location. In such cases, microphone(s) 106 may include sound localization software or other algorithm or component configured to generate a localization of a detected sound or audio source and determine coordinates (also referred to herein as “localization coordinates”) that represent a location or position of the detected audio source, relative to the microphone(s) 106 (or the microphone array in which the microphone(s) 106 are located). In other embodiments, the sound localization component may be included in the audio activity analyzer, the computing device 114, or other audio processing device external to the microphone(s) 106. In such cases, the microphone(s) 106 may provide the audio signals directly to the localization component for generating the localization data and other processing. Various methods for generating sound localizations are known in the art, including, for example, generalized cross-correlation (“GCC”), phase-transformed GCC (“PHAT-GCC”), MUSIC, MVDR, super resolution techniques such as ESPRIT, and/or others.

According to various embodiments, the localization coordinates may be Cartesian or rectangular coordinates that represent a location point in three dimensions, or x, y, and z values. For example, the location data may include a first set of coordinates (x1, y1, z1) that represents a location of a first audio source relative to a first subset of the microphone(s) 106 (e.g., two or more microphone elements included within a given microphone array or other audio device) and a second set of coordinates (x2, y2, z2) that represents a location of the first audio source relative to a second subset of the microphone(s) 106 (e.g., two or more other microphone elements included within the same microphone array or in a second microphone array or other audio input device). In some cases, the localization coordinates may be converted to polar or spherical coordinates, i.e. azimuth (phi), elevation (theta), and radius (r), for example, using a transformation formula, as is known in the art. The spherical coordinates may be used in various embodiments to determine additional information about the audio system, such as, for example, a distance between the audio source and a given microphone array and/or a distance between two microphones. Such distance information may be used to automatically configure and/or assign an audio zone, as described herein. In other embodiments, the localization coordinates may be converted to a common coordinate system (e.g., global or universal coordinate system, a room-specific or other local coordinate system, etc.) that is used throughout the audio system and/or environment 100 for ease of communication between devices and calculation of distance measurements and the like.

In some embodiments, the location data also includes a timestamp or other timing information that indicates the time at which each set of coordinates was generated by the relevant microphone(s) 106, an order in which the coordinates were generated, and/or any other information that helps identify coordinates that were generated simultaneously, or nearly simultaneously, for the same audio source. In embodiments that includes multiple microphones 106, the microphones 106 may have synchronized clocks (e.g., using Network Time protocol or the like). In other embodiments, the timing, or simultaneous output, of the coordinates may be determined using other techniques, such as, for example, setting up a time-synchronized data channel for transmitting the localization coordinates from the microphone(s) 106 to the computing device 114 and/or one or more processors, and more.

In embodiments, the audio activity information received at the one or more processors and/or the computing device 114 further comprises audio source distance information, or a measurement of the distance between the location of the detected audio (i.e. the audio source location) and the location of the microphone 106 that detected the audio signal or activity. The audio source distance may be determined or calculated based on the microphone location and the localization coordinates and/or other location data included in or associated with the audio source location, using known techniques, such as the localization techniques described herein. In some cases, the audio source distance may be further calculated, or refined, based on a height of the microphone, for example, where only the audio source direction (e.g., azimuth and elevation angles) is known, or the audio source distance information is of poor quality. In some cases, the microphone location may be known and previously stored in a memory of the audio system and/or computing device 114. In other cases, the microphone location may be calculated or estimated based on the audio activity detected by the at least one microphone 106. In either case, the audio source distance may be calculated by the at least one microphone 106 and/or the audio activity analyzer, and may be provided to the one or more processors as part of the audio activity information. In various embodiments, additionally or alternatively, non-audio sensors (e.g., video, infrared, etc.) and/or artificial intelligence may be used to determine the audio source distance.

The audio activity information can also include other types of data associated with a given audio signal. For example, the audio activity information can further comprise an audio source identifier that indicates the type of audio, or audio source, detected by the at least one microphone 106 at the corresponding audio source location. In embodiments, the audio source identifier may indicate detection of a voice signal if the audio signal comprises human speech or other vocal sounds. The audio source identifier may indicate detection of a near-end audio source if the audio signal comprises near-end audio, such as, speech or other audio produced by near-end talkers located around the table 104. The audio source identifier may indicate detection of a far-end audio source if the audio signal comprises far-end audio, such as speech or other audio playing on the loudspeaker(s) 108. The audio source identifier may indicate detection of a noise source if the audio signal comprises persistent noise (e.g., HVAC noise from the house source 110), double-talk audio (e.g., due to far-end audio interference), or other known or identifiable noise. In some cases, the audio source identifier may indicate detection of a combined audio source, or a combination of voice and noise audio or other combination of desired and undesired audio.

In order to ascertain the audio source identifier for a given audio signal, the audio activity analyzer may be configured to analyze or assess the audio signal generated by the microphone(s) 106 based on captured audio, as well as the audio activity information associated therewith, to determine whether the captured audio comprises human speech, noise, or a combination of noise and speech. In addition, the audio activity analyzer may make further assessments, e.g., based on the audio activity information or other data derived therefrom, to determine the type of speech or voice signal (e.g., near-end audio, far-end audio, double-talk audio, off-axis audio, acoustic reflection audio, etc.), the type of noise signal (e.g., persistent noise, intermittent noise, background or environmental noise, etc.), and/or the type of mixed signal (e.g., composition of noise, composition of voice, etc.). Based on the results of these assessments, the audio activity analyzer may assign an appropriate audio source identifier or predefined code (e.g., Voice, Noise, Near-end, Far-end, Off-axis, etc.) to the corresponding audio source location, or the location at which the audio was detected by the microphone(s) 106.

To assist with these assessments, the audio activity information may further include an audio quality score (or localization quality score) for each audio signal generated by the at least one microphone 106. The audio quality score may be a measure of the speech quality of the audio signal, or whether the audio signal contains voice (or human speech) sounds, non-voice sounds (or the absence of speech), or noise sounds. The audio quality score may be calculated, by the audio activity analyzer, the microphone(s) 106, or another component of the audio system, based on other audio activity information and/or other aspects of the audio signal. For example, the speech quality score may be a numerical metric that indicates a relative strength of the voice activity found in the audio signal (e.g., on a scale of 1 to 5), a binary value that indicates whether voice is found (e.g., “1”) or noise is found (e.g., “0”) in the audio signal, a harmonicity value that indicates a level of harmonics in the audio signal (e.g., on a scale of 0 to 1), or any other suitable measure. In embodiments, a higher audio quality score may indicate a voice signal, a lower score may indicate a noise signal, and a middle score may indicate a mix of voice and noise audio.

In some embodiments, the audio activity analyzer can be configured to use the audio quality score, the underlying sound localization information, and/or other audio activity information to further determine whether a voice signal contains on-axis speech or off-axis speech. The audio activity analyzer may be configured to indicate detection of on-axis speech or audio if, for example, the audio signal includes voice signals (or sounds) produced while the corresponding talker is facing the microphone 106 that generated the audio signal. On the other hand, the audio activity analyzer may be configured to indicate detection of an off-axis audio source if, for example, the audio signal includes voice signals produced while the talker is facing away from the microphone 106 that generated the audio signals voice signals produced by an adjacent talker that leaked into the audio signal; acoustic reflections of voice signals produced by a nearby talker (e.g., outside the inclusion zone but within the corresponding audio coverage area), or any other off-axis audio.

Various techniques may be used to determine an audio quality score for each audio signal, the type of audio included in an audio signal (e.g., human speech or voice, persistent noise, errant non-voice noise, etc.), and/or the type of voice signal detected (e.g., on-axis speech, off-axis speech, acoustic reflections, etc.), as will be appreciated. For example, the audio activity analyzer may include or use a voice activity detector (or “VAD”), such as, e.g., a cepstral voice activity detector, or use any other suitable detector or component to implement voice activity detection techniques, including the techniques described in co-owned U.S. patent application Ser. No. 18/397,693, the contents of which are incorporated by reference herein in their entirety. The voice activity detector can analyze the structure of an audio signal and use energy estimation techniques, zero-crossing count techniques, cepstrum techniques, machine-learning or artificial intelligence methods, cues from video associated with the event, or any other suitable techniques to identify or differentiate voice sounds (e.g., human speech) and noise sounds (e.g., non-voice audio), detect the presence or absence of human speech in a given audio signal, and/or to identify or differentiate far-end audio and near-end audio. As an example, with respect to near-end audio, the voice activity detector may differentiate between stationary noise and near-end speech or voice based on the energy of the signal, or may differentiate between non-stationary noise and near-end speech using cepstrum techniques, machine-learning or artificial intelligence methods, or the like. In addition, the voice activity detector may use any suitable speech processing algorithm to determine a voice or speech quality of captured sound and calculate a numerical audio quality score for the corresponding audio signal, as described herein.

In some cases, the audio activity analyzer may be configured to differentiate between far-end audio and near-end audio, or otherwise identify the presence of far-end audio or double-talk audio in a voice signal generated based on the captured audio (i.e. a voice signal that has been identified as fully or primarily containing voice or human speech), by comparing the voice signal to the far-end audio signal (i.e. the signal provided to the loudspeaker(s) 108 for playback), or a far-end reference signal based on the same. If a substantial or complete match is found, the audio activity analyzer may be configured to determine that the microphone signal contains the loudspeaker signal, or double-talk audio due to the loudspeaker signal echoing at the far-end, and assign a far-end noise identifier to the corresponding audio source location, which may be positioned close to one of the loudspeaker(s) 108 or other far-end audio source. If, on the other hand, zero or little overlap is found, and the voice signal has a high audio quality score, the audio activity analyzer may be configured to assign a near-end audio identifier to the corresponding audio source location.

In some embodiments, the audio activity analyzer and/or the audio zone component can be configured to assign audio source identifiers and/or create the audio zones 116 based further on previously known or stored audio source locations in the environment 100. For example, the locations of the loudspeaker(s) 108 or other far-end audio source in the environment 100 may be previously entered by the user or automatically discovered by the one or more processors of the audio system, and may be stored in a memory of the audio system and/or computing device 114. In such cases, the audio activity analyzer may be configured to compare a newly-generated voice signal to the known loudspeaker locations in order to determine whether the audio source is located at or near one of the loudspeakers 108. If it is, the audio activity analyzer may classify the voice signal as far-end audio and/or assign a far-end audio identifier to the corresponding audio source location. In some cases, the audio zone component may be configured to automatically create a far-end zone 116b that encompasses both the loudspeaker position and the detected far-end audio source locations once a sufficient number (e.g., at least three, at least five, etc.) of far-end audio source locations are identified at or near the loudspeaker position. In some cases, the audio zone component may be configured to dynamically adjust a size, shape, and/or boundary of the far-end zone 116b as new far-end audio source locations are identified, in order to include the newly detected audio source locations as well. In other cases, the audio zone component may be configured to automatically designate or create a far-end zone 116b around each known loudspeaker position and to automatically adjust, reshape, or otherwise configure one or more boundaries of the far-end zone 116b based on the far-end audio source locations identified in the vicinity of the loudspeaker position.

As will be appreciated, similar techniques may be used to create the HVAC zone 116b or other exclusion zone 116b and/or the near-end zones 116a or other inclusion zones 116a. For example, the location of the HVAC system 110 or other expected noise source in the environment 100 may be previously known and stored. In such cases, the audio activity analyzer may be configured to use the known noise source locations to identify audio signals detected at or near those locations as noise audio, and/or assign noise audio identifiers to the corresponding audio source locations. In some cases, the audio zone handler may be further configured to create and/or adjust noise zones 116c at least partially based on the known noise source locations.

As another example, the locations of the table 104 and/or the chairs 102, or other expected locations for near-end talkers in the environment 100, may be previously entered by the user, automatically discovered, or otherwise known and stored in the memory. In such cases, the audio zone handler may be configured to use the known near-end talker locations to identify voice signals generated based on audio detected at or near those locations as near-end audio, and/or assign near-end audio identifiers to the corresponding audio source locations. In some cases, the audio zone handler may be configured to automatically create and/or adjust inclusion zones 116a at least partially based on the known near-end talker locations.

While FIGS. 1 and 2 shown the audio zones 116 as having rectangular shapes, it should be appreciated that the audio zones 116 can have any appropriate size or shape, including, for example, square, circle, oval, triangle, hexagon or other polygon, or any other shape. Also, the exact number of audio zones 116 may vary depending on the placement, size, spacing, and overall configuration of the audio sources in the environment 100.

In environments that include multiple microphones 106 and/or multiple loudspeakers 108, the audio zone handler can be further configured to assign each audio zone 116 to one or more of the audio devices located in the environment 100 based on the audio activity information. For example, the audio zone assignments, or affiliations, may be automatically made based on the locations of the audio zones relative to the locations of the audio devices, and said location information may be obtained either directly or indirectly (e.g., derivable from the audio source locations, etc.) from the audio activity information. In such cases, the audio zone handler can be configured to assign each of the exclusion zones 116b to a select one of the loudspeakers 108 depending on the relative positions of the loudspeakers 108, or which of the loudspeakers 108 is located closest to the given exclusion zone 116b. For example, the first exclusion zone 116b located near the table 104 may be assigned to the first loudspeaker 108 located above the table 104, and the second exclusion zone 116b located near the second loudspeaker 108 may be assigned to the second loudspeaker 108. Similarly, the audio zone handler may be configured to automatically assign each of the inclusion zones 116a to a select microphones 106 depending on the relative positions of the microphones 106, or which of the microphones 106 is closest to the given inclusion zone 116a. For example, the first inclusion zones 116a that are located around the table 104 may be assigned to the first and second microphones 106 located above the table 104, and the second inclusion zone 116b located near the presentation unit 112 may be assigned to a microphone (not shown) located at or within the unit 112.

In some cases, the audio zone handler may be configured to assign each of the audio zones 116 to select audio devices (e.g., microphone(s) 106) based on the audio quality scores received for the audio signals generated based on detected audio and/or other audio activity information. For example, the audio quality scores may indicate whether the voice signals generated by the microphone(s) 106 have a high localization quality, exhibit on-axis or off-axis behavior, and/or contain acoustic reflections (e.g., off of the table 104). Based on these assessments, the audio zone handler can determine which of the audio zones 116 is best suited to process audio coming from a specific microphone 106, or otherwise handle the corresponding audio source (e.g., a near-end talker or other human speaker located near the microphone 106).

As an example, in various embodiments, the audio zone handler can be configured to assign one of the inclusion zones 116a or one of the modification zones 116c to the microphone 106 that captured a given audio signal based on whether the audio signal contains on-axis audio or off-axis audio. If the audio quality score indicates the presence of on-axis audio, for example, due to the corresponding talker facing the microphone 106 that captured the audio, the audio zone handler may assign the closest inclusion zone 116a to the microphone 106 that captured the on-axis audio. If, on the other hand, the audio quality score and/or other audio activity information indicates the presence of off-axis audio, for example, due to the corresponding talker facing away from the microphone 106 that captured the audio or being located outside the inclusion zone 116a but within an audio coverage area 118, the audio zone handler may assign the closest modification zone 116c to that microphone 106. As described herein, assignment to the modification zones 116c enables further processing of the audio signals detected therein, for example, by correcting the off-axis noise included in the corresponding voice signal.

In various embodiments, the establishment and assignment of audio zones 116 can further enhance operation of other audio processing algorithms included in or used by the audio system or its affiliates, such as, for example, algorithms involving beamforming and null steering, gain-adjustment, audio mixing, sound reinforcement (e.g., voice lift), and more. In particular, the audio zones 116 may enable individual audio processing algorithms to act more quickly and precisely due to the establishment of set preferences for each type of zone 116, which removes or reduces the need to act on individual parameter estimates from separate algorithms (such as, e.g., VAD, localization, etc.) during run-time, and thus enables the audio system, as a whole, to achieve targeted synergy between its algorithms (e.g., coverage areas, AEC, gain policy, camera tracking, audio mixing, etc.). For example, one set of gain adjustment parameters may be applied to off-axis audio captured in the modification zones 116c established throughout the room, while a different set of gain adjustment parameters may be applied to on-axis audio captured in the inclusion zones 116a established throughout the room.

The audio zones 116 can also improve operation of cameras (e.g., camera 208 of FIG. 3), automatic camera directors, and other equipment in the environment 100 that uses sound localization information, audio quality scores, and/or other audio activity information to control one or more operations of said equipment. For example, estimated talker locations (or audio source locations), including talker orientation based on an estimation of on-axis audio source, can be used to automatically position a camera, or an image capturing component of said camera, towards an active talker in the environment 100. In such cases, an accuracy of the estimated talker location largely may determine how well the camera can track the talker or keep the talker within a frame or viewing angle of the camera, especially if the talker is moving, for example, in their chair 102, around the table 104, or about the room 100. In embodiments, the audio system and/or the computing device 114 can be configured to provide the audio activity information and/or the audio signals captured in the inclusion zones 116a to one or more cameras in the environment 100 to enable improved audio and image processing.

Thus, the audio system of environment 100 can be configured to establish or automatically create the audio zones 116 for optimally handling or processing audio signals generated by the one or more microphones 106 based on the audio activity information associated with the audio signals, such as, e.g., audio source location, audio source type, audio type, audio quality information, etc. The audio system can also be configured to assign or affiliate each audio zone 116 to appropriate audio devices included in the environment 100 based on the audio activity information, such as, e.g., audio quality scores, relative locations of the microphones 106, the loudspeakers 108, and the established audio zones 116, etc. Through these assignments, detected noise and other undesired audio can be easily attenuated, processed in order to remove the undesired portions, and/or provided to other components of the system to help with other forms of audio processing (e.g., echo cancellation, audio mixing, automatic gain adjustment, etc.), and in some cases, image processing (e.g., camera 208 of FIG. 3).

Referring now to FIG. 3, shown is an exemplary audio system 200 configured to carry out one or more of the audio zone creation and/or configuration operations described herein, in accordance with embodiments. As shown, the audio system 200 comprises a computing device 202 and one or more audio devices. The audio devices can include at least one microphone 204, at least one loudspeaker 206, and/or other types of audio devices (e.g., conferencing device, etc.). In some embodiments, the audio system 200 further includes a camera 208 as one of the audio devices. In various embodiments, the audio system included in the environment 100 (i.e., as shown in FIGS. 1 and 2) may be implemented using the audio system 200 (also referred to as an “audio conferencing system”). For example, the computing device 114 may be implemented using the computing device 202, each microphone 106 may be implemented using the microphone 204, and each loudspeaker 108 may be implemented using the loudspeaker 206.

The computing device 202 may be communicatively coupled to each of the audio devices using a wired connection (e.g., Ethernet, USB or other suitable type of cable) or a wireless network connection (e.g., WiFi, Bluetooth, Near Field Communication (“NFC”), RFID, infrared, etc.). For example, in some embodiments, one or more of the microphone 204 and the loudspeaker 206 may be network audio devices coupled to the computing device 202 via a network cable (e.g., Ethernet) and configured to handle digital audio signals. In other embodiments, the audio devices of the audio system 200 may be analog audio devices or another type of digital audio device, and may be connected to the computing device 202 using a Universal Serial Bus (USB) cable or other suitable connection mechanism.

According to various embodiments, one or more components of the audio system 200 may be embodied in a single hardware device. For example, the microphone(s) 204 and the loudspeaker(s) 206 may be included in a single audio device (e.g., a network audio device or the like). As another example, one or more of the microphone(s) 204 and the loudspeaker(s) 206 may be included in the computing device 202, for example, as a native or built-in audio speaker or microphone.

In some embodiments, the computing device 202 can be physically located in and/or dedicated to the given environment or room, for example, as shown in FIG. 1. In other embodiments, the computing device 202 can be part of a network and/or distributed in a cloud-based environment. In various embodiments, the computing device 202 resides in an external network, such as a cloud computing network. In some embodiments, the computing device 202 may be implemented with firmware or completely software-based as part of a network, which may be accessed or otherwise communicated with via another device, including other computing devices, such as, e.g., desktops, laptops, mobile devices, tablets, smart devices, etc.

As shown in FIG. 3, the computing device 202 may comprise one or more processors 210, a memory 212, and/or a user interface 214 for carrying out the techniques described herein, including automatically creating a plurality of audio zones in a given environment or room based on received audio activity information. The components of the computing device 202 may be communicatively coupled by system bus, network, or other connection mechanism (not shown). In various embodiments, the computing device 202 may be a personal computer (PC), a laptop computer, a tablet, a smartphone or other smart device, other mobile device, thin client, a server, or other computing platform. In such cases, the computing device 202 may further include other components commonly found in a PC or laptop computer, such as, e.g., a data storage device, a native, or built-in, microphone device, and a native audio speaker device. In some embodiments, the computing device 202 is a standalone computing device, such as, e.g., the computing device 114 shown in FIG. 1, or other control device that is separate from the other components of the audio system 200. In other embodiments, the computing device 202 resides in another component of the audio system 200, such as, e.g., the at least one microphone 204 or an audio device that also includes one or more of the microphone(s) 204 and the loudspeaker(s) 206.

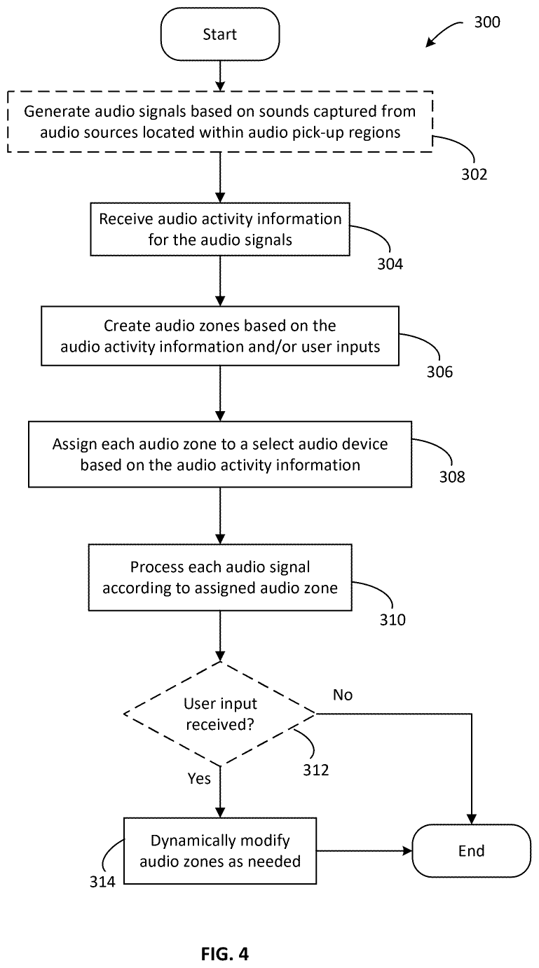

The one or more processors 210 execute instructions retrieved from the memory 212. In embodiments, the memory 212 stores one or more software programs, or sets of instructions, that embody the techniques described herein. When executed by the processor 210, the instructions may cause the computing device 202 to implement or operate all or parts of the techniques described herein, one or more components of the audio system 200, and/or methods, processes, or operations associated therewith, such as, e.g., process 300 shown in FIG. 4. For example, as shown in FIG. 3, the memory 212 may include an audio zone handling component or software module 216 (also referred to herein as “audio zone handler”) that is configured to cause the computing device 202, or the one or more processors 210, to create, and/or adjust, a plurality of audio zones within the environment based on audio activity information, or otherwise carry out one or more operations of process 300 shown in FIG. 4. As another example, in some embodiments, the memory 212 may include an audio activity analyzing component or software module 218 (also referred to herein as “audio activity analyzer”) that is configured to cause the computing device 202, or the one or more processors 210, to analyze audio activity information received from, and/or associated with audio signals captured by, the at least one microphone 204, or otherwise carry out one or more operations of process 300 shown in FIG. 4.

In general, the computing device 202 can be configured to control and communicate or interface with the other hardware devices included in the audio system 200, such as the microphone(s) 204, the loudspeaker(s) 206, the camera 208, and/or any other devices in the same network. The computing device 202 may also control or interface with certain software components of the audio system 200. For example, in some embodiments, the audio activity analyzer 218 may be a separate software module that is installed or included in the at least one microphone 204 or another component of the audio system 200. In such cases, the computing device 202 may be configured to interface with the audio activity analyzer 218 in order to receive the audio activity information that is used by the audio zone handler 216 to create, assign, and/or configure audio zones.

The computing device 202 may include one or more communication interfaces (e.g., hardware or software-based) that are configured to enable the computing device 202 to communicate with other devices (or systems) according to one or more protocols, as will be appreciated. For example, the communication interface may enable the computing device 202 to transmit information to, and receive information from, the microphone 204, the loudspeaker 206, the camera 208, and/or other component(s) of the audio system 200. Such information may include, for example, audio activity information or other location data (e.g., sound localization coordinates), audio zone locations, assignments, and parameters (or boundaries); audio coverage area locations, assignments, and boundaries; lobe or pick-up pattern information, and more. In some embodiments, the computing device 202 may operate as an aggregator configured to aggregate or collect the audio activity information and/or other location data from appropriate audio devices, like the microphone(s) 204.

In some cases, the computing device 202 to communicate or interface with external components coupled to the audio system 200 (e.g., remote servers, databases, and other devices). For example, the computing device 202 may interface with a component graphical user interface (GUI or CUI) associated with the audio system 200 and any existing or proprietary conferencing software. In addition, the computing device 202 may support, one or more third-party controllers and in-room control panels (e.g., volume control, mute, etc.) for controlling one or more of the audio devices in the audio system 200.

User interface 214 may facilitate interaction with a user of the computing device 202 and/or audio system 200. As such, the user interface 214 may include input components such as a keyboard, a keypad, a mouse, a touch-sensitive panel, a microphone, and a camera, and output components such as a display screen (which, for example, may be combined with a touch-sensitive panel), a sound speaker, and a haptic feedback system. The user interface 214 may also comprise devices that communicate with inputs or outputs, such as a short-range transceiver (RFID, Bluetooth, etc.), a telephonic interface, a cellular communication port, a router, or other types of network communication equipment. The user interface 214 may be internal to the computing device 202, or may be external and connected wirelessly or via connection cable, such as through a universal serial bus port. In some embodiments, the user interface 214 may include a button, touchscreen, or other input device for receiving a user input for implementing the audio zones defined by the computing device 202, for reconfiguring or changing the audio zones, and/or other user-initiated actions described herein. In some embodiments, the user interface 214 may be used to implement an interactive graphical user interface or other tool for enabling the user to control and/or adjust the audio zones, as described herein.

The at least one microphone 204 may be any type of microphone, including one or more microphone transducers (or elements), a microphone array, or other audio input device capable of capturing speech and other sounds associated with the conference call, webcast, telecast, or other meeting or event. For example, the microphone 204 may include, but is not limited to, SHURE MXA310, MX690, MXA710, MXA910, MXA920, MXA901, MXA902, and the like. In embodiments, the microphone 204 may be configured to capture near-end audio associated with the conference call, meeting, or other event, or sounds produced by the near-end participants of the event (i.e., those located in the conferencing room or other environment). In some embodiments, the microphone 204 may be a standalone network audio device or a native microphone built into a computer, laptop, tablet, mobile device, or other computing device in the audio system 200. In other embodiments, the microphone 204 may be a microphone coupled to the computing device 202 using a wireless or wired connection (e.g., via a Universal Serial Bus (“USB”) port, an HDMI port, a 3.5 mm jack, a lightning port, or other audio port). In some cases, the microphone 204 includes a plurality of microphone transducers arranged in an array (i.e., a microphone array). While the illustrated embodiment shows one microphone 204, it should be appreciated that the audio system 200 may include multiple microphones 204 in other embodiments, for example, as shown in FIGS. 1 and 2.

The at least one loudspeaker 206 may be any type of audio speaker, speaker system, or other audio output device for audibly playing audio signals associated with the conference call, webcast, telecast, or other meeting or event. For example, the loudspeaker(s) 206 may include, but are not limited to, SHURE MXN5C-W and the like. In embodiments, the loudspeaker(s) 206 may be configured to play far-end audio signals associated with the conference call, meeting, or other event, or sounds produced by the far-end participants of the event (i.e., those not physically present in the conferencing room or other environment). In some embodiments, the loudspeaker(s) 206 may be a standalone network audio device that includes a speaker, a native speaker built into a computer, laptop, tablet, mobile device, or other computing device in the audio system 200. In other embodiments, the loudspeaker(s) 206 may be a loudspeaker coupled to the computing device 202 using a wireless or wired connection (e.g., via a Universal Serial Bus (“USB”) port, an HDMI port, a 3.5 mm jack, a lightning port, or other audio port). In some cases, the loudspeaker 206 includes a plurality of audio drivers arranged in an array (i.e., a speaker array). While the illustrated embodiment shows one loudspeaker 206, it should be appreciated that the audio system 200 may include multiple loudspeakers 206 in other embodiments, for example, as shown in FIG. 1.

The camera 208 can capture still images and/or video of the environment in which the audio system 200 is located. In some embodiments, the camera 208 may be a standalone camera, while in other embodiments, the camera 208 may be a component of an electronic device, e.g., smartphone, tablet, etc. In some cases, the camera 208 may be included in the same electronic device as the microphone 204, the loudspeaker 206, and/or the computing device 202. The camera 208 may be a pan-tilt-zoom (PTZ) camera that can physically move and zoom to capture desired images and video, or may be a virtual PTZ camera that can digitally crop and zoom images and videos into one or more desired portions. The system 200 may also include a presentation unit (e.g., presentation unit 112 of FIG. 1) or other display, such as, e.g., a television or computer monitor, for showing images and/or video content, including video of the remote participants of a conference call.

According to embodiments, the audio activity analyzer 218 can be configured to generate or receive audio activity information associated with a plurality of audio signals captured (or generated) by the microphone(s) 204 of the audio system 200. The audio activity information may comprise sound localization information (e.g., localization coordinates), an audio source location, an audio source identifier, and/or an audio quality score for each of the audio signals, for example. In some cases, the audio activity analyzer 218 may receive certain pieces of audio activity information from the microphone(s) 204 and may generate other pieces of audio activity information based thereon. For example, the audio activity analyzer 218 may receive localization coordinates and/or other sound localization information for a given audio signal, from the microphone 204 that generated the signal, and based thereon, calculate or estimate the audio source location for that signal, or the location of the talker or other audio source that produced the signal. In some cases, the audio activity analyzer 218 may also calculate or determine an audio quality score for the audio signal based on the sound localization information received from the microphone 204.

In embodiments, the audio zone handler 216 can be configured to receive the audio activity information from the audio activity analyzer 218. In addition, the audio zone handler 216 can be configured to create a plurality of audio zones (e.g., audio zones 116 in FIG. 1). In some embodiments, the audio zone handler 216 automatically creates the audio zones based on the received audio activity information. In other embodiments, the audio zone handler 216 creates the audio zones at locations indicated by one or more user inputs received via the user interface 214. In either case, the audio zone handler 216 can be configured to assign each audio zone to one or more of the audio devices based on the audio activity information, so that appropriate audio devices are handled by, or affiliated with, each of the audio zones. As shown in FIGS. 1 and 2, the plurality of audio zones may comprise one or more inclusion zones (e.g., zones 116a in FIG. 1) for capturing desired audio, one or more exclusion zones (e.g., zones 116b in FIG. 1) for removing or suppressing undesired audio, and one or more modification zones (e.g., zones 116c in FIG. 1) for processing the audio signals by removing the undesired audio from the audio signal. In such cases, the audio zone handler 216 can be configured to assign the exclusion zone(s) to the loudspeaker(s) 206, assign the inclusion zone(s) to the microphone(s) 204, and assign the modification zone(s) to other microphone(s) 204 that have been identified as capturing off-axis audio, acoustic reflections, or other audio signal comprising desired and undesired sounds. In the case of multiple audio devices, the audio zone handler 216 and/or the audio activity analyzer 218 may be configured to calculate the distance between the audio zones and respective audio devices and make zone assignments, or affiliations, based on relative positioning or, for example, which exclusion zone is closest to a given noise source, which inclusion zone is closest to a given microphone 204, etc.

FIG. 4 illustrates an exemplary method or process 300 for providing a plurality of audio zones (e.g., audio zones 116 of FIG. 1) in an environment (e.g., environment 100 of FIG. 1) having a plurality of audio devices to ensure optimal handling of audio signals captured or produced throughout the environment, in accordance with embodiments. The audio devices may be part of an audio system (e.g., audio system 200 of FIG. 3) and may including at least one microphone (e.g., microphone 204 of FIG. 3) and/or at least one loudspeaker (e.g., loudspeaker 206 of FIG. 3).

All or portions of the process 300 may be performed by one or more processors (e.g., processor(s) 210 of FIG. 3) and/or other processing devices (e.g., analog to digital converters, encryption chips, etc.) that are within or external to the audio system, including an audio processor in communication with the at least one microphone. In addition, one or more other types of components (e.g., memory, input and/or output devices, transmitters, receivers, buffers, drivers, discrete components, logic circuits, etc.) may also be used in conjunction with the one or more processors and/or other processing components to perform any, some, or all of the steps of the process 300. For example, the process 300 may be carried out by a computing device (e.g., computing device 202 of FIG. 3), or more specifically a processor of said computing device (e.g., one or more processors 210 of FIG. 3) executing software stored in a memory (e.g., memory 212 of FIG. 3), such as, e.g., the audio zone handler 216 and/or the audio activity analyzer 218 of the audio system 200, as shown in FIG. 3. In addition, the computing device may further carry out the operations of process 300 by interacting or interfacing with one or more other devices that are internal or external to the audio system and communicatively coupled to the computing device (e.g., microphone(s) 204, loudspeaker(s) 206, camera 208, or other audio device associated with the audio system 200 of FIG. 3).

As shown in FIG. 4, in some embodiments, the process 300 may comprise, at step 302, using at least one microphone, capturing sounds present within an audio pick-up region (e.g., audio coverage areas 118 of FIG. 1) assigned to the at least one microphone, and generating one or more audio signals based on the captured sound. In some cases, step 302 further comprises capturing the one or more audio signals from an audio source located within the audio pick-up region. In other cases, step 302 includes capturing the one or more audio signals from an audio source that is located outside the audio pick-up region but is detectable within the audio pick-up region (i.e. the sounds produced by audio source are detectable within the audio pick-up region).

In various embodiments, the process 300 includes, at step 304, receiving, at the one or more processors, audio activity information associated with audio signals generated by the at least one microphone. The at least one microphone may provide the audio signals to the one or more processors to generate and/or aggregate the audio activity information, for example, using an audio activity analyzer executed by the one or more processors (e.g., audio activity analyzer 218 of FIG. 3). The audio activity information may be collected from various audio devices in the environment, such as the at least one microphone and/or the at least one loudspeaker, over a period of time. The audio activity information may comprise or include sound localization data (e.g., localization coordinates), audio source location, and/or other location data, as well as audio quality score (e.g., voice/speech audio, noise audio, on-axis audio, off-axis audio, etc.), audio source identifier (e.g., microphone or other near-end audio source, loudspeaker or other far-end audio source, noise source, etc.), and/or other audio data, and any other suitable information associated with each audio signal generated by the at least one microphone, as described herein. In some cases, the one or more processors may be configured to use the received location data to determine relative positions of the audio devices (e.g., relative to a given audio zone) and/or a proximity of each audio device to a given audio zone and include that in the audio activity information. In some cases, this determination is based further on audio device location information that is previously-known and/or is included in the audio activity information.

In some embodiments, step 304 further includes collecting the audio activity information over a long period of time, e.g., as part of a historical data collection for the room or environment, and analyzing the collected information to identify expected audio source locations or other patterns that may be useful for placement of audio zones, as described herein. In some embodiments, step 304 includes receiving the audio activity information as part of a predefined setup procedure for the room or other environment, as described herein. For example, the process 300 may further include playing an audio test signal over each loudspeaker included in the audio devices, or otherwise detecting audio test signals in the environment, and aggregating audio activity information associated with the audio test signals, for example, in order to determine relative locations of the loudspeaker(s), the microphone(s), etc.

At step 306, the process 300 further comprises creating a plurality of audio zones (e.g., audio zones 116 in FIGS. 1 and 2) configured to optimally handle the different types of audio signals present in the environment, for example, using an audio zone handler executed by the one or more processors (e.g., audio zone handler 216 of FIG. 3). The plurality of audio zones can comprise one or more inclusion zones (e.g., inclusion zones 116a in FIGS. 1 and 2) for capturing desired audio (e.g., near-end audio, etc.) and one or more exclusion zones (e.g., exclusion zones 116b in FIGS. 1 and 2) for removing undesired audio (e.g., noise, far-end audio, double-talk audio, etc.). In some cases, the audio zones further comprise of one or more modification zones (e.g., modification zones 116c in FIGS. 1 and 2) for removing undesired audio from a given audio signal, such as, e.g., off-axis audio, acoustic reflections, etc. The one or more modification zones may be located outside the one or more inclusion zones but overlapping at least a portion of the at least one audio pick-up region used to capture the given audio signal.

In some embodiments, step 306 further comprises creating the audio zones at locations indicated by one or more user inputs received via a user interface of the audio system (e.g., user interface 214 of FIG. 3). For example, the user interface and the one or more processors may be configured to generate and/or present a graphical user interface tool for enabling user control and/or creation of the audio zones in a given environment.

In other embodiments, step 306 further comprises creating the audio zones based on the audio activity information received in association with the audio signals detected or generated by the at least one microphone. For example, step 306 may further comprise, based on the audio source identifier of a given audio signal indicating detection of a near-end audio source, automatically creating the one or more inclusion zones at or near the corresponding audio source location. Similarly, step 306 may further comprise, based on the audio source identifier for a given audio signal indicating detection of a far-end audio source or a noise source, automatically creating the one or more exclusion zones at or near the corresponding audio source location. In addition, step 306 may further comprise, based on the audio quality score for a given audio signal indicating detection of off-axis audio, or other mixture of desired audio and undesired audio, automatically creating a modification zone at or near the corresponding audio source location.

The process 300 further comprises, at step 308, assigning each of the plurality of audio zones to one or more of the audio devices, or other audio sources in the environment (e.g., noise sources), based on the received audio activity information, for example, using the audio zone handler. In embodiments where the one or more processors are configured to perform a predefined setup procedure, for example, before a conference call or other event takes places in the environment, step 308 may be performed as part of that setup procedure and the audio activity information may be associated with the audio test signals played during the procedure. In some cases, the one or more processors may be configured to receive, or retrieve, the audio activity information from a memory storing historical audio activity information collected over a longer period of time.

In various embodiments, the assigning at step 308 may include assigning each audio zone to an appropriate audio device based on the audio source identifier, audio quality score, and/or other audio data associated with the audio signals generated by or near each audio device (e.g., assign the inclusion zone to a microphone, the exclusion zone to a loudspeaker, etc.). For example, upon determining that the audio signals generated by at least one microphone correspond to near-end audio or other desired audio, the one or more processors may be further configured to assign the one or more inclusion zones to the at least one microphone. Likewise, upon determining that the audio signals detected around the loudspeaker are loudspeaker signals containing far-end audio or other undesired audio, the one or more processors may be configured to assign a select one of the one or more exclusion zones to the at least one loudspeaker.

In embodiments where there are multiple audio devices of a particular type (e.g., plurality of microphones, plurality of loudspeakers, etc.), the assigning at step 308 may further include, based on relative positioning of the audio devices, automatically assigning each audio zone to the appropriate audio device that is located closest to the zone. For example, in embodiments where the at least one microphone comprises a first microphone (e.g., “Mic 1” in FIG. 1) and a second microphone (e.g., “Mic 2” in FIG. 1), the one or more inclusion zones may comprise a first inclusion zone and a second inclusion zone, and the one or more processors may be further configured to, based on relative positions of the first microphone and the second microphone, assign the first inclusion zone to the first microphone and assign the second inclusion zone to the second microphone. Similarly, in embodiments where the at least one loudspeaker comprises a first loudspeaker (e.g., speaker 1 in FIG. 1) and a second loudspeaker (e.g., speaker 2 in FIG. 1), the one or more exclusion zones may comprise a first exclusion zone and a second exclusion zone, and the one or more processors may be further configured to, based on relative positions of the first loudspeaker and the second loudspeaker, assign the first exclusion zone to the first loudspeaker and assign the second exclusion zone to the second loudspeaker.

While FIG. 4 shows steps 304 and 306 in a particular order, it should be appreciated that the steps, as well as other steps in the process 300, may be performed in any order. For example, in embodiments where the audio zones are created manually, or based on user inputs, step 306 may occur before or as the audio activity information is received at step 304, since the initial creation of audio zones is not dependent on received audio activity information in those cases. Instead, the audio activity information is used, e.g., at step 308, to automatically assign the audio zones to appropriate audio devices or other audio sources. Thus, step 308 may follow step 304 in such embodiments, for example.

At step 310, the process 300 includes processing or handling each audio signal according to the audio zone in which the audio signal is detected, or the audio zone that is assigned to the audio device or source that produced the audio signal, for example, using the audio zone handler. In particular, audio signals captured within the inclusion zones may be provided to an audio mixer or audio processor to generate a near-end (or desired) audio mix for sending to remote participants of the conferencing call or other event. Audio signals generated based on audio detected within the exclusion zones may be provided to an audio processor or audio mixer in order to suppress or attenuate the signals, or otherwise prevent the undesired or noise audio detected in those zones from being added to the near-end audio mix. And audio signals captured within the modification zones may be provided to an audio processor to correct off-axis audio included in the captured signals, or otherwise modify the audio detected in the modification zones to separate or extract desired voice signals. Said processed audio may then be provided to an audio mixer, for example, to add the desired audio to the near-end audio mix, and/or to an audio processor, for example, to help enhance other audio processing techniques (e.g., noise reduction, echo cancellation, automatic gain adjustment, sound reinforcement, etc.), as described herein.

In some embodiments, the process 300 further comprises, at step 312, determining or detecting whether a user input for changing one or more boundaries of a select one of the plurality of audio zones has been received via the user interface. For example, step 312 may be present in embodiments where the audio zone handler is configured to present a graphical user interface tool for adjusting or configuring the audio zones. If the determination at step 312 is “yes,” the process 300 continues to step 314, which includes dynamically modifying the audio zones as indicated by the user input. If the determination at step 312 is “no,” the process 300 may end, or return back to start and wait for newly-generated audio signals.

In other embodiments, for example, where the audio zone handler automatically configures and reshapes the audio zones based on received audio activity information, the process 300 may continue from step 310 directly to step 314. In such cases, the one or more processors may be configured to dynamically modify the audio zones in response to detecting one or more changes in the room or environment. For example, based on the audio signals generated using audio detected within each zone and analyzed by the audio activity analyzer, the one or more processors may be configured to determine when a new audio source (e.g., talker, microphone, speaker, etc.) enters the audio zone, existing audio sources become inactive or move to new locations within the audio zone, the room configuration changes (e.g., table and/or chairs are moved, etc.), or any other detectable, audio-impacting change occurs.

Regardless of whether the audio zones are manually or automatically modified, the dynamic modification at step 314 may include: expanding or enlarging an audio zone by moving one or more boundaries of the audio zone outwards to include additional audio devices or sources within the audio zone; shrinking or reducing the size of an audio zone by moving one or more boundaries of the audio zone inwards to exclude or remove an audio device or source from the audio zone; splitting an audio zone that is too large into two zones; combining two smaller audio zones into one zone; or any other alteration or fine-tuning of the audio zones. Once the audio zones are modified as needed, the process 300 may end, or return back to start and wait for audio signals generated based on newly-detect audio.

In some embodiments, the audio zone handler may be configured to constantly monitor the audio activity information and/or other audio properties of the environment, and dynamically modify the audio zone type (e.g., inclusion, modification, or exclusion) of all or a portion of a given audio zone upon detecting a significant change in the audio localizations. For example, the one or more processors may change an inclusion zone (and/or provide a user a recommendation for a new inclusion zone, e.g., via a user interface) to a modification zone upon determining that an audio quality of the audio signals generated in that zone has dropped to low or poor quality (e.g., based on the audio quality scores for those signals) and have been consistently or frequently detected as low quality for a preset period of time. The preset period of time may vary depending on the type of audio signal being generated and/or the type of change recommendation, and may be, e.g., five minutes, ten minutes, twenty minutes, one hour, etc. In addition, or alternatively, the one or more processors may change an inclusion zone to a modification zone upon determining that the audio signals have been generated based on audio detected in unexpected areas of the zones (e.g., not at the chairs 102 or around the table 104 in FIG. 1), thus indicating that the near-end talkers may have moved about the room, the room configuration may have changed, and/or the talkers may be facing away from the microphones, for example. If the audio zone handler determines that the low quality audio signals (e.g., indicating off-axis audio) are present in only a smaller portion of the inclusion zone and the remainder of the zone continues to produce high quality audio signals, the audio zone handler may change only the smaller portion of the inclusion zone to a modification zone and leave the rest of the inclusion zone as is. In some cases, if excessive discrepancy or change is detected, or if a large number of small automatic adjustments are needed, the audio zone handler may be configured to alert or notify the user that a reconfiguration is needed.

Thus, the techniques described herein provide systems and methods for using audio activity information, such as, e.g., sound localization data and audio quality scoring, associated with audio signals generated by one or more microphones to create audio zones (e.g., inclusion or exclusion) that are optimized to handle specific types of audio signals, and assign affiliations between the audio zones and select audio devices, or sources, in the environment, to ensure appropriate handling of newly-detected audio, whether desired, undesired, or a mix of both.

Referring back to FIG. 3, any of the processors described herein, such as, e.g., processor 210, may include a general purpose processor (e.g., a microprocessor) and/or a special purpose processor (e.g., an audio processor, a digital signal processor, etc.). In some examples, processor 210, and/or any other processor described herein, may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs).

Any of the memories or memory devices described herein, such as, e.g., memory 212, may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, memory 212, and/or any other memory described herein, includes multiple kinds of memory, particularly volatile memory and non-volatile memory.

Moreover, any of the memories described herein (e.g., memory 212) may be computer readable media on which one or more sets of instructions, such as the software for operating the techniques described herein, can be embedded. The instructions may reside completely, or at least partially, within any one or more of the memory, the computer readable medium, and/or within one or more processors (e.g., processor 210) during execution of the instructions. In some embodiments, memory 212, and/or any other memory described herein, may include one or more data storage devices configured for implementation of a persistent storage for data that needs to be stored and recalled by the end user, such as, e.g., location data received from one or more audio devices, prestored location data or coordinates indicating a known location of one or more audio devices, and more. In such cases, the data storage device(s) may save data in flash memory or other memory devices. In some embodiments, the data storage device(s) can be implemented using, for example, SQLite data base, UnQLite, Berkeley DB, BangDB, or the like.

In some embodiments, any of the computing devices described herein, such as, e.g., the computing device 202, may include one or more components configured to facilitate a conference call, meeting, classroom, or other event and/or process audio signals associated therewith to improve an audio quality of the event. For example, in various embodiments, the computing device 202, and/or any other computing device described herein, may comprise a digital signal processor (“DSP”) configured to process the audio signals received from the various audio sources using, for example, automatic mixing, matrix mixing, delay, compressor, parametric equalizer (“PEQ”) functionalities, acoustic echo cancellation, and more. In other embodiments, the DSP may be a standalone device operatively coupled or connected to the computing device using a wired or wireless connection. One exemplary embodiment of the DSP, when implemented in hardware, is the P300 IntelliMix Audio Conferencing Processor from SHURE, the user manual for which is incorporated by reference in its entirety herein. As further explained in the P300 manual, this audio conferencing processor includes algorithms optimized for audio/video conferencing applications and for providing a high quality audio experience, including eight channels of acoustic echo cancellation, noise reduction and automatic gain control. Another exemplary embodiment of the DSP, when implemented in software, is the IntelliMix Room from SHURE, the user guide for which is incorporated by reference in its entirety herein. As further explained in the IntelliMix Room user guide, this DSP software is configured to optimize the performance of networked microphones with audio and video conferencing software and is designed to run on the same computer as the conferencing software. In other embodiments, other types of audio processors, digital signal processors, and/or DSP software components may be used to carry out one or more of audio processing techniques described herein, as will be appreciated.

Various components of the computing device 202, and/or any other computing device described herein, may be implemented in hardware (e.g., discrete logic circuits, application specific integrated circuits (ASIC), programmable gate arrays (PGA), field programmable gate arrays (FPGA), etc.), using software (e.g., program modules comprising software instructions executable by a processor), or through a combination of both. For example, some or all components of the computing device 202, and/or any other computing device described herein, may use discrete circuitry devices and/or use a processor (e.g., audio processor, digital signal processor, or other processor) executing program code stored in a memory, the program code being configured to carry out one or more processes or operations described herein. In embodiments, all or portions of the processes may be performed by one or more processors and/or other processing devices (e.g., analog to digital converters, encryption chips, etc.) within or external to the computing device 202. In addition, one or more other types of components (e.g., memory, input and/or output devices, transmitters, receivers, buffers, drivers, discrete components, logic circuits, etc.) may also be utilized in conjunction with the processors and/or other processing components to perform any, some, or all of the operations described herein. For example, in FIG. 3, program code stored in the memory 212 of the computing device 202 may be executed by the processor 210 of the computing device 202, by a separate digital signal processor coupled to or included in the computing device 202, or by a separate audio processor in order to carry out one or more of the operations described herein. In some embodiments, the program code may be a computer program stored on a non-transitory computer readable medium that is executable by a processor of the relevant device.

Moreover, the computing device 202, and/or any of the other computing devices described herein, may also comprise various other software modules or applications (not shown) configured to facilitate and/or control the conferencing event, such as, for example, internal or proprietary conferencing software and/or third-party conferencing software (e.g., Microsoft Skype, Microsoft Teams, Bluejeans, Cisco WebEx, GoToMeeting, Zoom, Join.me, etc.). Such software applications may be stored in the memory (e.g., memory 212) of the computing device and/or may be stored on a remote server (e.g., on premises or as part of a cloud computing network) and accessed by the computing device via a network connection. Some software applications may be configured as a distributed cloud-based software with one or more portions of the application residing in the computing device (e.g., computing device 202) and one or more other portions residing in a cloud computing network. One or more of the software applications may reside in an external network, such as a cloud computing network. In some embodiments, access to one or more of the software applications may be via a web-portal architecture, or otherwise provided as Software as a Service (SaaS).

It should be understood that examples disclosed herein may refer to computing devices and/or systems having components that may or may not be physically located in proximity to each other. Certain embodiments may take the form of cloud based systems or devices, and the term “computing device” should be understood to include distributed systems and devices (such as those based on the cloud), as well as software, firmware, and other components configured to carry out one or more of the functions described herein. Further, as noted above, one or more features of the computing device may be physically remote (e.g., a standalone microphone) and may be communicatively coupled to the computing device.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

Any process descriptions or blocks in the figures, such as, e.g., FIG. 4, should be understood as representing modules, segments, or portions of code that include one or more executable instructions for implementing specific logical functions or steps in the process, and alternate implementations are included within the scope of the embodiments described herein, in which functions may be executed out of order from that shown or discussed, including substantially concurrently or in reverse order, depending on the functionality involved, as would be understood by those having ordinary skill in the art.

Further, it should be noted that in the description and drawings, like or substantially similar elements may be labeled with the same reference numerals. However, sometimes these elements may be labeled with differing numbers, such as, for example, in cases where such labeling facilitates a more clear description. In addition, system components can be variously arranged, as is known in the art. Also, the drawings set forth herein are not necessarily drawn to scale, and in some instances, proportions may be exaggerated to more clearly depict certain features and/or related elements may be omitted to emphasize and clearly illustrate the novel features described herein. Such labeling and drawing practices do not necessarily implicate an underlying substantive purpose. The above description is intended to be taken as a whole and interpreted in accordance with the principles taught herein and understood to one of ordinary skill in the art.

In this disclosure, the use of the disjunctive is intended to include the conjunctive. The use of definite or indefinite articles is not intended to indicate cardinality. In particular, a reference to “the” object or “a” and “an” object is intended to also denote one of a possible plurality of such objects.

Moreover, this disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, which may be amended during the pendency of the application for patent, and all equivalents thereof, when interpreted in accordance with the breadth to which they are fairly, legally and equitably entitled.

What is claimed is:

1. A method using one or more processors in communication with a plurality of audio devices located within an environment, the audio devices comprising at least one microphone, the method comprising:
receiving audio activity information associated with audio signals generated by the at least one microphone based on captured audio;
creating a plurality of audio zones within the environment based on the audio activity information, wherein the plurality of audio zones comprise one or more inclusion zones for capturing desired audio, and one or more exclusion zones for removing undesired audio; and
based on the audio activity information, assigning each of the plurality of audio zones to one or more of the audio devices.

2. The method of claim 1, wherein assigning each of the plurality of audio zones comprises: assigning a select one of the one or more exclusion zones to at least one loudspeaker included in the plurality of audio devices.

3. The method of claim 2, wherein the one or more exclusion zones comprises a first exclusion zone and a second exclusion zone, the at least one loudspeaker comprises a first loudspeaker and a second loudspeaker, and assigning each of the plurality of audio zones comprises: based on relative positions of the first loudspeaker and the second loudspeaker, assigning the first exclusion zone to the first loudspeaker and assigning the second exclusion zone to the second loudspeaker.

4. The method of claim 1, wherein assigning each of the plurality of audio zone comprises: assigning the one or more inclusion zones to the at least one microphone.

5. The method of claim 1, wherein the one or more inclusion zones comprises a first inclusion zone and a second inclusion zone, the at least one microphone comprises a first microphone and a second microphone, and assigning each of the plurality of audio zones comprises: based on relative positions of the first microphone and the second microphone, assigning the first inclusion zone to the first microphone and assigning the second inclusion zone to the second microphone.

6. The method of claim 1, wherein the audio activity information comprises an audio source location and an audio source identifier for a given audio signal, and creating a plurality of audio zones comprises: based on the audio source identifier indicating detection of a far-end audio source or a noise source, creating the one or more exclusion zones at or near the corresponding audio source location.

7. The method of claim 1, wherein the audio activity information comprises an audio source location and an audio source identifier for a given audio signal, and creating a plurality of audio zones comprises: based on the audio source identifier indicating detection of a near-end audio source, creating the one or more inclusion zones at or near the corresponding audio source location.

8. The method of claim 1, wherein the environment further includes at least one audio pick-up region assigned to the at least one microphone, the method further comprising: using the at least one microphone, capturing one or more of the audio signals from an audio source detected within the at least one audio pick-up region.

9. The method of claim 8, wherein the plurality of audio zones further comprises at least one modification zone located outside the one or more inclusion zones but overlapping at least a portion of the at least one audio pick-up region, the method further comprising: processing an audio signal generated based on audio captured within the modification zone by correcting off-axis audio included in the audio signal.

10. An audio system located in an environment, the audio system comprising:
a plurality of audio devices including at least one microphone configured to generate audio signals based on captured audio; and
one or more processors in communication with the plurality of audio devices, the one or more processors configured to:
receive audio activity information associated with the audio signals generated by the at least one microphone;
create a plurality of audio zones within the environment based on the audio activity information; and
based on the audio activity information, assign each of the plurality of audio zones to a select one of the plurality of audio devices,
wherein the plurality of audio zones comprises one or more inclusion zones for capturing desired audio, and one or more exclusion zones for removing undesired audio.

11. The audio system of claim 10, wherein assign each of the plurality of audio zones comprises: assign a select one of the one or more exclusion zones to at least one loudspeaker included in the plurality of audio devices.

12. The audio system of claim 11, wherein the one or more exclusion zones comprises a first exclusion zone and a second exclusion zone, the at least one loudspeaker comprises a first loudspeaker and a second loudspeaker, and assign each of the plurality of audio zones further comprises: based on relative positions of the first loudspeaker and the second loudspeaker, assign the first exclusion zone to the first loudspeaker and assign the second exclusion zone to the second loudspeaker.

13. The audio system of claim 10, wherein assign each of the plurality of audio zones comprises: assign the one or more inclusion zones to the at least one microphone.

14. The audio system of claim 10, wherein the one or more inclusion zones comprises a first inclusion zone and a second inclusion zone, the at least one microphone comprises a first microphone and a second microphone, and assign each of the plurality of audio zones further comprises: based on relative positions of the first microphone and the second microphone, assign the first inclusion zone to the first microphone and assign the second inclusion zone to the second microphone.

15. The audio system of claim 10, wherein the audio activity information comprises an audio source location and an audio source identifier for a given audio signal, and create a plurality of audio zones comprises: based on the audio source identifier indicating detection of a far-end audio source or a noise source, create the one or more exclusion zones at or near the corresponding audio source location.

16. The audio system of claim 10, wherein the audio activity information comprises an audio source location and an audio source identifier for a given audio signal, and create a plurality of audio zones comprises: based on the audio source identifier indicating detection of a near-end audio source, create the one or more inclusion zones at or near the corresponding audio source location.

17. The audio system of claim 10, wherein the environment further includes at least one audio pick-up region assigned to the at least one microphone, the at least one microphone configured to generate one or more of the audio signals based on audio produced by an audio source detected within the at least one audio pick-up region.

18. An audio system located in an environment, the audio system comprising:
a plurality of audio devices including at least one microphone configured to generate audio signals based on captured audio;
a user interface configured to receive one or more user inputs; and
one or more processors in communication with the user interface and the plurality of audio devices, the one or more processors configured to:
create a plurality of audio zones within the environment at locations indicated by the one or more user inputs;
receive audio activity information associated with the audio signals generated by the at least one microphone; and
based on the audio activity information, assign each of the plurality of audio zones to a select one of the plurality of audio devices,
wherein the plurality of audio zones comprises: one or more inclusion zones for capturing desired audio, and one or more exclusion zones for removing undesired audio.

19. The audio system of claim 18, wherein the audio activity information comprises an audio source location and an audio quality score for a given audio signal, and the one or more processors are further configured to: based on the audio quality score indicating a presence of off-axis audio, create a modification zone at or near the corresponding audio source location; and process the given audio signal to correct the off-axis audio.

20. The audio system of claim 18, wherein the user interface is configured to receive a second user input and the one or more processors are further configured to: change one or more boundaries of a select one of the plurality of audio zones based on the second user input.
